(19) United States
(12) Patent Application Publication
(10) Pub. No.: US 2012/0073382 A1
(43) Pub. Date: Mar. 29, 2012

(54) METHOD AND DEVICE FOR TESTING THE STABILITY OF A POLE

(75) Inventors: Horst Spaltmann, Wesel-Blumenkamp (DE); Wolfhard Zahlten, Wetter (DE); Renato Eusani, Solingen (DE); Michael Hortmanns, Neuss (DE)

(73) Assignee: Axel MEYER, Wesel-Bislich (DE)

(21) Appl. No.: 13/318,859

(22) PCT Filed: May 4, 2010
(86) PCT No.: PCT/EP2010/056052

§ 371 Date: Dec. 5, 2011

(30) Foreign Application Priority Data
May 5, 2009 (DE) 10 2009 002 818.8

(51) Int. Cl. G01N 3/00

(52) U.S. Cl. 73/788

(57) ABSTRACT

The invention relates to a method for testing the stability of a mast standing on a substrate or of a similarly standing system. According to such a method for testing the stability of a standing system, the natural frequency of a mast to be examined is determined. By the aid of the natural frequency, a measure for the stability is determined computationally and/or numerically and evaluated on the basis of the determined measure for stability. A device is comprised of the means to be able to implement such a testing method in automatized manner.

The invention relates to a method for testing the stability of a mast standing on a substrate or of a similarly standing system.

Masts are utilized, for example, as supporting beams for lightings (e.g. floodlight masts), traffic signs, traffic lights, ropes such as overhead lines for electricity or rope for ropeways (e.g. for high-voltage masts, catenary masts of railways or tramways) or antennae (e.g. transmission masts radio broadcasting, television or cellular mobile radio). An electricity mast is a pole or column, e.g. made of wood or metal and anchored in the substrate and comprised of at least one electrically live conductor fastened in the upper area.

Above all, ambient influences such as soil moisture and wind or vandalism may damage a mast or a similar system, for example by corrosion, material fatigue or formation of cracks, and jeopardize its stability. Hence the stability of a mast should be checked within regular intervals. Therefore it is to be verified whether a mast to be checked is damaged that much that it needs to be replaced.

A frequently implemented procedure to check the stability of a mast is applying a horizontally acting load on the masts by the aid of a mobile equipment. Displacements occurring in the process are measured. Upon removal of the load, a check is made subsequently for whether the mast has again attained its initial position. In numerous cases, this method is disadvantageous and no non-destructive method, for example because
Damaged masts do not attain their initial position any more and will then usually stand obliquely;
Loads applied are higher than effectively possible loads due to a wind impact. Masts may suffer damage due to the test load, although they had still been stable.

Crooked or damaged masts usually have to be replaced instantly, in particular if the masts carry electrically live cables. To an operator this implies a substantial logistical expenditure which usually calls for proper short-term organization. Testing methods involving an introduction of loads furthermore bear a disadvantage in that only faults underneath the point of load introduction are checked. Faulty spots above the point of load introduction are not covered by these testing methods.

Another method applicable to wooden masts resides in reboring the masts by the aid of a special drilling device. It records the force required for a constant drilling progress. A decreasing force suggests that there are defective spots inside the wood cross-section. This method, too, bears various drawbacks:
First of all, this method is no non-destructive method;
As the drilling is usually done at the base only, it is merely possible to make statements on this area only. Strictly speaking, only the drilling spot itself can be evaluated. It is impossible to make a statement on the behaviour of the foundation in its entirety.

A sophisticated method resides in running the test with the aid of special ultrasonic devices. First of all, this test is a discrete testing method, i.e. only a certain measuring point and a certain cross-section, respectively, is examined and tested. To obtain a holistical image, the measurements must be taken at different points of the mast. And this is relatively costly. One may only draw conclusions on whether or not the tested spots evidence any damage. It is impossible to render a direct static evaluation.

Procedures for testing the stability of a mast according to which a mast is statically loaded are known from prior art, e.g. from printed publications DE-OS 15 73 752 as well as EP 0638 794 B1. In conformity with these printed publications, the measure for the stability is the deflection of a mast subjected to a pre-defined force which a mast is charged with.

The printed publication DE 29910833 U relates to a mobile testing unit for measuring the stability of a mast comprised of a rack resting on the ground soil and to be connected to the mast base, said rack also comprising means for loading the mast with a test load. A first measuring unit designed to check the mast deflection caused by the test load is attached to the rack. A second measuring unit which is mechanically independent of the rack serves to determine movements of the first measuring unit. This testing appliance is relatively costly and in particular it is not easy to transport it to a mast to be tested.

The printed publication DE 10028872 A discloses a method of the initially mentioned kind. To test the stability of an overhead line mast built in grid construction type, a force pulse is exerted on the corner column, measuring and evaluating the reaction of the environment by the aid of seismographic sensors. This procedure is unable to render precise findings and/or results for different types of masts.

It is furthermore known to attach a mass rotating about the mast at a desired height. The mast is so set in vibrations which should represent a measure for its stability. A procedure of this kind according to which a mast is thus periodically charged with a force may be gathered from DE 103 00 947 A1, for example. The vibration behaviour of the mast is evaluated on the basis of various criteria. Conclusions as to the stability of the mast tested are drawn thereof. A procedure of this kind is also disadvantageous because it represents a relatively imprecise non-standardized procedure.

Such a procedure is imprecise in particular if the vibration behaviour depends on ambient conditions. Above all, this holds for a mast which carries overhead lines. Depending on the prevailing temperature, the sag of a wire rope varies and thus, the vibration behaviour and/or the natural frequency of a mast to be tested vary, too. Hence there are discrepancies in the vibration behaviour which are attributable to the prevailing ambient conditions rather than to damage that might have occurred to a mast and jeopardized its stability.

Disclosed in printed publication EP1517141A is a method for reviewing the stability, more particularly the corrosion impairment of metal masts which are partly embedded in a substrate. The metal mast is set in vibrations and these vibrations are measured with a measuring appliance. Vibration measurement data thus obtained are compared with vibration measurement data of an intact identical mast. If discrepancies occur between those vibration measurement data obtained and those recorded, such discrepancies suggest that an impairment has occurred. The disadvantage here resides in that the vibration behaviour of an intact mast must be newly measured for each new mast. For each new mast it must be newly defined what discrepancies of a vibration behaviour call for a replacement of a mast due to a lack of stability. Discarded are those discrepancies of the vibration behaviour which are attributable to prevailing individual conditions. And again this represents a non-standardized relatively imprecise testing method.

Now, therefore, it is the object of the present invention to provide a method and a device by means of which the stability of a mast can be examined in a practical, non-destructive and reliable manner.

To solve this task, a natural frequency of a mast to be examined is determined. The natural frequency determined is utilized to derive a measure for the stability of a mast. Depending on the measure for stability determined from the natural frequency it is ascertained whether a mast is sufficiently stable.

To be able to determine a natural frequency of a mast it is sufficient to slightly set the mast to be examined in vibrations and to record the vibration behaviour with one or more acceleration sensors. For those reasons outlined further below, too, the mast should not be exposed to heavy loads because heavy loads might damage the mast. To be able to determine natural frequencies it is not required either to set a mast in vibrations in an exactly defined always identical manner. Frequently it is even not required and not desired either to generate mast vibrations artificially. Hence it may be sufficient to record the vibrations which, for example, are caused by natural external loads such as wind loads.

By difference to prior art, the displacement and/or deflection of the mast head, in particular, due to external load is calculated by the aid of the natural frequency and determined by applying a numerical method. External load should not be understood to mean the weights which a mast has to bear constantly as intended. External load does not mean the deadweight of the mast to be reviewed either. External load in particular results from a prevailing wind. If a mast is climbed by a person, this also represents an external load in the sense of the present invention.

Based on the deformation behaviour and/or mast deflection, the stability is evaluated. The deformation behaviour of a mast represents a well suitable measure to be able to evaluate the stability of a mast. In particular, this measure allows for obtaining more reliable statements on the stability as compared to the case according to which merely the vibration behaviour or natural frequency itself is utilized as a measure for the stability.

Therefore, the method can be implemented in a simple manner and thus in a practicable and reproducible way. Hence it is possible to execute reviews for stability in such a manner that the findings and results obtained reliably reflect the actual stability of a mast.

Natural frequency depends on the stiffness of a mast and therefore it permits evaluating the stiffness of a mast. The stiffness of a mast, in turn, is a variable that permits evaluating the deflection of a mast due to a load. An appropriately determined stiffness may already be sufficient to be able to determine the stability in a better way as compared with prior art. In particular, this is valid if a design stiffness of the system which can be compared with the appropriately determined stiffness has been determined from the admissible deformations. A determined stiffness is particularly suitable if it describes the overall stiffness of the system prevailing at the time of taking the measurement.

A mast usually tapers towards the top, for example a mast consisting of lumber (wooden mast). A mast like an electricity mast furthermore is comprised of attachments built-on. Such attachments in case of an electricity mast are fastening elements for electrical lines, in particular. Moreover, an electricity mast is mechanically loaded by the electrical conductors fastened to it. These differences as compared to a simple mast, e.g. a cylindrically shaped mast, take an influence on natural frequency. Besides, the natural frequency of a mast depends on the height and/or elevation at which these attachments are mounted. Therefore, in one embodiment of the present invention, such system parameters of a mast flow into the determination of the deformation behaviour (deflection or displacement of the mast head). It means that the calculation or numerical determination of the deformation behaviour also takes account of the system parameters of a mast. If a calculation or numerical determination of the deformation behaviour does not cover any system parameters, then no system parameters of a most flow into the determination of the deformation behaviour. System parameters are:
Height of the mast to be evaluated;
Mast diameter as well as—based thereon—the variation of the mast diameter as it increases and/or decreases in height;
Material of the mast such as type of wood (beech, oak, pine, etc.), steel, aluminum, concrete, etc.;
Number of wire ropes with masts provided with wire rope attachments;
Rope diameter of wire ropes with masts provided with wire rope attachments;
Material or weight of wire ropes, inasmuch as available;
Wire rope sagging with masts provided with rope attachments on the date of taking the measurement;
Height of fixing points for attachments built-on and/or ropes (inasmuch as existing);
Weight of attachments built-on, e.g. fixing elements for electrical conductors/wire, ropes;
E-module of the mast (usually it results from the material of the mast—with wood it is advantageous to consider the material moisture prevailing on the day of taking the measurement);
Distance between adjacent masts which are connected to each other via a wire rope attachment;
Position of additional masses such as lamps, isolators, spreaders, antennae, ladders (to be able to climb-up a mast);
Magnitude of additional masses such a lamps, isolators, spreaders, antennae, ladders (to be able to climb-up a mast);
Weight of additional masses such as lamps, isolators, spreaders, antennae, ladders (to be able to climb-up a mast);

In one embodiment of the invention, the deflection of a mast and/or a corresponding measure due to an external load by wind etc. is determined by considering the loads a mast has to bear, including the deadweight of the mast. The loads and masses to be borne by the mast as intended influence its natural frequencies so that considering these loads and masses contributes to improving the evaluation of its stability. Unless these loads and masses flow into the computation or numerical determination of the deflection, these loads and masses are not considered in the sense of the present invention.

However, the natural frequency of a mast is not only influenced by loads and masses constantly burdening a mast, but above all by the height at which the loads and masses to be borne are located. In one embodiment of the invention, therefore, the height(s) is (are) taken into account at which the loads and masses to be borne by a most to be examined are located in order to thus be able to come to an improved evaluation of the stability of a mast. Unless such heights and/or elevations flow into the computation or numerical determination of the deflection (deformation) and/or a corresponding measure, such heights and/or elevations are not considered in the sense of the present invention.

Moreover, the natural frequency of a mast is influenced by the position and magnitude of a mass to be borne by a mast. For example, it matters whether a mass burdens a mast equally or unequally, because a mass is solely affixed to one side of the mast. If a mass is solely affixed laterally, it also matters to what extent the mass point of gravity lies laterally of the mast axis. For this reason, among others, the magnitude and shape of a mass, i.e. of the object the weight of which is contemplated takes an influence on natural frequency. In a comparable manner, it is also significant how high and/or low a mass extends to, proceeding from a fixing point at the mast. Therefore, in one embodiment of the invention, the magnitude and/or shape of such a weight is also taken into account in order to be thus able to improve the evaluation of the stability of a mast.

In one embodiment of the invention, the masses to be borne by a mast including its deadweight, the elevations at which these masses are located are summarized to one value which in the following is called “generalized mass”. Besides, the position, shape and/or magnitude of masses to be borne can flow into the generalized mass M_{gen}. In one embodiment, this generalized mass flows into the computation or numerical determination of a measure for the deflection in order to thus be able to improve the evaluation of the stability of a mast still further.

The generalized mass flows into the numerical or computational determination of the deflection searched for in particular as follows:

$${Ω}^{2} ∼ \frac{1}{generalized mass} ,$$

where Q=2π·natural frequency fₑ.

The generalized mass differs from the weighable mass of a mast including the masses to be borne by the mast by a dynamic component which influences the stability of a mast as well as its natural frequency.

To be able to determine a generalized mass, the weight of the mast apart from the distribution of the weight is determined at first, for example. To this effect, the diameter of the mast at the lower end above its anchoring as well as at least the diameter which the mast has got at its tip are determined. The diameter at the mast tip can be determined by the aid of tapers taken from tables which define typical dimensions for masts (e.g. RWE Guideline). Thereby, for example in case of a homogeneously tapering lumber mast, the volume of the mast is determined. By determination of the specific density of the material, i.e. for example of the lumber depending on the lumber type as well as by way of moisture measurements taken on the day of measurement, the specific mass of the wood on the day of measurement is determined. Determined hereof is the weight of the lumber mast which is decisive on the date of taking the measurement.

In terms of their weight, the attachments built-on are usually known and/or defined by the mast operator. Hence, these are eventually determined by conventional weighing, i.e. prior to being affixed to a mast.

Moreover it is determined at which elevation the attachments are affixed. This is done by way of length and/or height measurements.

Defined and thus known is the material as well as the diameter of the ropes which are hung to a mast with rope attachments. Moreover, the distance between two adjacent masts is also determined. Furthermore, it is possible to take a temperature measurement. Assuming a previously known rope sagging with a given temperature, it is thus possible to compute how much the ropes sag between two masts and how strong the weight force is which is exerted on the mast due to a sagging rope. Alternatively, the rope sagging is measured directly on the date of measurement. The measured temperature then serves for computing the wire rope sagging at given temperatures which are crucial for the evaluation. By the aid of this rope sagging, the rope forces are computed. High temperatures may be unfavorable, because in that case the rope sagging will decrease and the reset spring from the wire rope attachments will decrease down to a minimum. Therefore, the test is preferably run when the prevailing outside temperature is less than 30° C. Preferably the outside temperature will then be at least 0° C. in order to avoid adulterations due to icing.

Then it is determined how strongly a mast to be examined is vertically burdened by the wire ropes. This value is a temperature-dependent value because depending on the temperature the rope sagging intensity is different.

A sagging rope affixed to a mast introduces a vertical and a horizontal force onto the mast. Therefore, in particular in connection with ropes, even those resetting forces are determined which impact on the mast in horizontal direction.

In one embodiment of the invention, in case of a mast with rope attachments, only those deflections resulting from external loads are considered as a measure for the stability of a mast which proceed vertically to a rope that is borne by a mast. It was found out that above all these deflections are of some interest in evaluating the stability so that the method and procedure can then be reduced to this contemplation. The stiffness of a mast with rope attachments in one direction in parallel to the run of the rope attachments is approx. 50 to 100 times higher than it is in comparison to the vertical direction. This stiffness and/or the corresponding deflection under external load is therefore preferably not determined and thus neglected.

Hence the critical direction is the a.m. vertical direction to the wire ropes. A hazard to the stability is particularly posed due to the wind load or manload. Manload plays an important part, for example if a person climbs up a mast for maintenance purposes. This is usually done laterally of a wire rope attachment of masts, for example laterally of electrical conductors of electricity masts because otherwise the person concerned would not be able to climb-up to the ropes.

To be able to determine natural vibrations of a mast, acceleration sensors are attached to the mast, for example at a defined elevation, according to one embodiment of the invention. However, the precise elevation need not be known. The acceleration sensors must merely be attached high enough to be able to measure accelerations occurring. The minimum elevation at which the sensors have to be mounted, therefore, also depends on the sensitivity of the sensors. It is impossible to take any measurements at the mast base because here almost no vibrations occur. An elevation at an average person's breast height has turned out to be sufficient. Commercially obtainable sensors usually are sufficiently sensitive to allow for taking measurements of vibrations at this height with sufficient accuracy.

In principle, it is applicable that the measuring accuracy improves as the height increases. However, then there will be a problem in how to affix the device. Hence, in order to be able to implement the method especially easily, the sensors are preferably mounted at an elevation that can still be reached by an operator without any problems. Additional equipment such as ladders thus become dispensable. The measuring accuracy at this elevation is also sufficient at the same time.

In one embodiment of the invention, acceleration sensors are affixed at different elevations in order to thus obtain more precise data and information on the vibration behaviour of a mast. Hereby the ability to evaluate the stability of a mast can still be further improved.

In a first embodiment of the present invention, a certain period of time is awaited after affixing the acceleration sensors until the mast swings measurably due to environmental impacts such as wind. In many cases, this is already sufficient to be able to determine the desired natural vibrations. If this is insufficient, the mast is artificially set in vibrations. In many cases, this can be done manually by an operator applying a corresponding dynamic force onto the mast.

In one embodiment of the invention, the moment when a force is to be exerted onto a mast is signalized manually, for example by means of a reciprocating signal, for instance an audible signal, in order to set it appropriately in vibrations. The audible signal is preferably given in a such a way that resonance vibrations are generated in order to generate suitable vibrations with a light force.

The cycle with which a force is to be exerted onto the mast in order to generate natural vibration and/or resonance vibration can be determined from an initial still relatively imprecise measurement. An initial measurement supplies a frequency spectrum. The first peak of the frequency spectrum belongs to the first natural frequency. If the time scribe of the measuring signal is converted by the aid of a Fourier analysis into a frequency spectrum, the cycle of a reciprocating audible signal results from the position of the first peak.

Hence, in one embodiment of the invention, an initial measurement is taken in such a manner that continuous vibrations due to natural interferences from the environment are measured. A second measurement taken as a consequence of an artificial excitation is preferably taken from a defined minimum acceleration onward. Not until this minimum acceleration has been reached will the measuring values be recorded. In this manner, the natural frequency searched for can be determined especially precisely and easily.

In one embodiment of the method, care is taken to ensure that a mast to be examined is not excited too strongly. Too strong an excitation is preferably examined again by the aid of at least one acceleration sensor and, for example, displayed by the aid of a signal. Alternatively or in supplementation thereto, in case of too strong an excitation, the recording of the vibration behaviour is automatically stopped. For it is of a certain advantage to contemplate the quasi-static case. And because a differentiation should be taken between a quasi-static and a dynamic stiffness. If a mast is excited to fast vibrations, then the effective soil stiffness is much greater as compared with a quasi-static case. The physical background resides in that on account of the mass inertia and on account of the flow resistance in the soil pores, water in the soil area cannot be displaced quickly enough. As a consequence, it results a much greater soil stiffness as compared with the quasi-static case. In the quasi-static case, the water is displaced, thus obtaining a much lower stiffness in the quasi-static case. For evaluating the stability, the quasi-static case is of particular relevance.

The procedure is therefore advantageously implemented only with small excitations even though substantially greater vibration frequencies would be feasible under stability aspects.

In one embodiment of the invention, the mast is therefore excited by a load that ranges between 1 and 10% of the envisaged maximum load that can and/or may be exerted on such a mast.

A second measurement which is based on the fact that the mast has previously been excited artificially serves the purpose of being able to determine natural frequency more precisely. The more measurements are taken, the lower is the measuring inaccuracy in relation to natural frequency searched for.

Nevertheless, the procedure can already be implemented successfully with one measurement. In that case one would merely have to put up with a major inaccuracy. If accelerations are measured frequently in a different manner, it thereof merely results a more precise determination of the natural frequency searched for. In principle, however, the method and procedure is not altered thereby.

In one embodiment of the invention, an appropriate measure for the stability is determined by utilizing the relation

Ω²˜C_{gen}.

Preferably an appropriate measure for the stability is determined by utilizing the equation

$${Ω}^{2} = \frac{{C}_{gen}}{generalized mass} .$$

C_{gen} is a measure for stiffness which can already be utilized as a measure in order to be able to improvedly evaluate its stability,

$${C}_{gen} = {( \frac{1}{torsional stiffness} + \frac{1}{bending stiffness} )}^{- 1} + rope stiffness$$

Of special interest is the torsional stiffness of a mast in order to be able to evaluate the stability of a mast. When taking the measurements with a sensor, it considers all the discrepancies versus a non-damaged system.

Rope stiffness relates to the ropes supported by a mast with wire rope attachments. Rope stiffness C_{S} is determined from the resetting force resulting on deflection of a mast. More precise explanations are described further below.

To determine the flexural stiffness of a mast to be examined, it is above all the mast length that is determined and taken into account. One has to differentiate between the overall length of a mast and the length which protrudes versus the terrain top edge. On determination of the flexural stiffness, the length which protrudes versus the terrain plays a significant part. This length is therefore measured, for example.

If flexural stiffness and rope stiffness, if required, have been determined, the torsional stiffness can be calculated. It is above all the torsional stiffness that permits rendering a statement on how to assess the stability of a mast.

In one embodiment of the invention, based on a mast stiffness determined, more particularly based on the torsional stiffness of a mast to be examined, it is determined, for example by a simulation or computation, how severely a mast would deform due to a wind load, more particularly due to a maximally possible and/or envisaged wind load. Contemplated here in particular is the displacement of the mast head (hereinafter briefly referred to as “head point displacement”) caused thereby. This deformation or displacement is an especially well suitable measure to be able to judge stability. For it has become evident that all faults that might question stability are already contained in the “head point displacement” information. It has become evident that it is therefore not required to precisely determine where the fault is located, e.g. at which elevation. It has quite surprisingly been found out that the head point displacement already contains data and information on faults that are located above the acceleration sensors. Hence it can be derived thereof whether the stability of a mast is sufficiently given. If the simulated or computed displacement of a mast head exceeds a defined limit value, the mast must be replaced. Preferably there are several different defined limit values which characterize the degree of hazard. For example, exceeding a maximal defined limit value may imply that a mast has to be replaced instantly. Exceeding a lower defined value may imply that a mast has to be replaced within a defined period of time.

In one embodiment of the present invention, a classification into classes orientates itself by those classes specified in EN 40-3-3 in Table 3.

EN 40-3-2:2000 stipulates that deformation at a mast tip falls into one of those classes specified in Table 3 of EN 40-3-3 (EN 40-3-2:2000, Section 5.2, Subparagraph b)). It means: if deformation is greater than class 3 deformation, the mast is instantly deemed non-admissible. Within the scope of the evaluation, this deformation limit is therefore expediently interpreted as the greatest admissible value. EN 40 allows each country to define which class the masts have at least to fulfill nationwide. (EN 40-3-3:2000, Annex B, Subparagraph B.2). Within the scope of the inventively proposed evaluation it is understood that in Germany class 1 masts have always to be set. It means: if deformations at mast tip are less than or equal to the limit values for class 1 in Table 3 from EN 40-3-3, the mast is deemed acceptable. In one embodiment, class 2 and 3 limit values are inventively utilized to enable a refined assessment. It means a mast evidencing deformations for class 2 or 3 has negatively changed versus the status as installed (class 1). This change inventively represents a reduction of stability. Masts the deformations of which are less than class 3 limit values are always stable. For class 2 and 3 masts, however, a change has occurred which in principle represents the result of a time-dependent process. The mast properties, will continue to change accordingly. According to the present invention, the following recommendations have been derived hereof empirically above all for lumber masts:
Class 1: Mast is acceptable without any restrictions
Class 2: Mast is no longer climbable, but still stable
Class 3: Mast is not climbable, conditionally stable, must be replaced within 3 months
>Class 3: Mast is no longer stable, must be replaced instantly.

It is furthermore supposed that deformations correlate directly with the pertinent limit loads. It means: a mast evidencing substantial head point deformations has a smaller limit load than a mast with little head point deformations. Assuming an average surplus strength of 7% and supposing only class A masts as per Table 1 from EN 40-3-3:2000 may be used, then according to EN 40-3-2:2000 the smallest limit load must at least be approx. 1.5 times as large as the test load (characteristic load, e.g. due to wind).

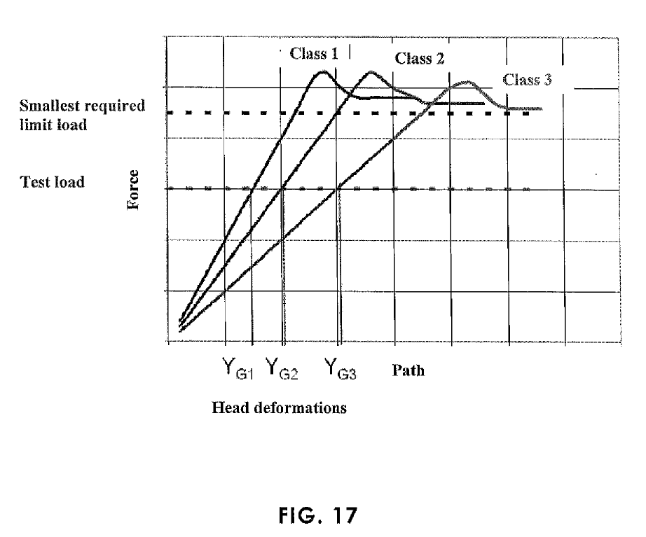

This condition applies to all classes of masts. However, since the test loads are equal for all loads, it means the limit load for class 3 is approx. 1.5 times the test load, and for the other classes the limit load is at least equally large, and usually even larger. This correlation is outlined in FIG. 17. Shown here is a schematic correlation between deformations and limit loads including classes pursuant to EN 40. The exact rupture load (limit load) is not ascertained by the method. However, the evaluation of stability is conservative and on the safe side.

In one embodiment of the present invention, it is determined how a mast would displace and shift at various elevations if exposed to a simulated wind load. Then, too, defined limit values may have been stipulated as to each elevation in order to enable an improved assessment of the hazard posed to a mast.

For lighting masts, for example, there are defined limit values from the very beginning on for mast deflections which must not be exceeded. However, in numerous cases these do have nothing in common with the stability but with considerations for their use. Nevertheless, such limit values may also be utilized to assess stability.

In the same manner, one may contemplate a mast deformation due to a manload in order to thus be able to judge stability.

To implement the method and procedure, a test appliance is provided for which is comprised of data input means such as a keyboard or means for speech recognition and output means such as a monitor screen and/or loudspeakers. The device is comprised of means to enable measuring and above all recording vibrations. The device may be comprised of sensors to enable measuring the moisture of a material a mast to be examined consists of. The device may be comprised of a temperature sensor to be able to determine the outside temperature prevailing on the day of measurement. The device may be comprised of a GPS receiver or the like in order to be able to determine the position during a measurement. For example, via the position automatically determined by the GPS link, it is possible to automatically record which mast was examined and what the result of this measurement had been. Errors can thus be minimized. In one embodiment, the coordinates ascertained via GPS are utilized to automatically record the mast distances and/or field lengths without taking any further distance measurements. The device may be comprised of wireless communication means to obtain online-searched data and/or system parameters furnished by a mast operator. This in turn may be automatized considering the automatically determined location of the device. Data and information required beyond this scope can be entered via input means, e.g. a keyboard, into the device. In its configuration, the device is moreover so designed and built that by means of this device the determined test findings and results are transmitted to the relevant operator of a tested mast so that corresponding databases automatically contain up-dated information on stability. Complementary or alternatively, the device may furnish a test result via an output means such as a monitor screen or printer. In particular, the device is comprised of a computing unit properly programmed to automatically determine a searched measure for stability upon entry of the input information required. In one embodiment of the present invention, the device is comprised of a cycle generator to define a cycle with which a mast is to be set in vibrations. Moreover, in one embodiment of the present invention, the device is comprised of a counter which registers the number of applications, stipulates maintenance intervals or allows for setting-up a billing model according to which a fee is to be paid per application. In one embodiment of the present invention, a lower and/or upper limit value are saved and/or provided for in the device to start recording vibrations depending on the lower limit value and/or starting the recording process depending on the upper limit value.

In one embodiment, limit values for the excitated acceleration are saved in the device which are utilized to enable the issue of a warning in case of too great excitation amplitudes. This warning is given through an audible alarm that is issued via the same loudspeaker as the cycle generator.

In another embodiment of the invention, the device is comprised of means for computing a specific lower and upper threshold set to the natural frequency to be measured. In the spectrae, these limits are illustrated, for example, on a monitor screen so that a user is enabled to check the measured result for plausibility. Faults are thus avoided.

The invention allows for performing a non-destructive test procedure by the aid of vibration measurements in order to be able to assess the stability of masts. The result of this procedure is a parameter or a measure by which it can be decided whether the stability of a mast is given. In certain embodiments of the present invention, criteria like the head point displacement of the mast due to horizontal loads (wind) and vertical loads (manloads) and/or a distortion of the foundation are considered in the evaluation.

By applying a more sophisticated measuring technique (more sensors), the present invention also allows for drawing conclusions as to statically relevant cross section values (area and moment of inertia). In this case, stress analyses are also feasible and purposive, because these are then carried out for the residual cross sections.

The invention can be universally applied to masts made of different materials, e.g.:
Wooden masts, e.g. as overhead line masts in low voltage and medium voltage range or for telephone lines
Steel masts, e.g. as lamp, antennae, traffic sign or traffic light masts
Aluminium masts, e.g.

Masts may have various cross sections, e.g.:
Solid cross section
Ring-shaped cross section
Polygonal cross sections (e.g. hexagonal, octagonal)
Graduated cross section run
Conical cross section run.

The inventive test method can be applied independently of the relevant cross section shape.

By way of the invention, it is also possible to computationally take account of built-on components such as lamps, traffic signs, isolators, spreaders or wire ropes which due to their mass and moments of inertia influence the natural frequencies of masts, as lamp, antennae, traffic sign or traffic light masts.

Furthermore, the invention makes it possible to take account of reset forces due to possibly existing wire rope attachments (with overhead line masts) or guys, because the overall stiffness of the system is thereby influenced.

The explanations given below elucidate the embodiments of the invention and initially aim at coming to an analytical solution. The principle of the method can thus be outlined in a simpler manner. However, one may also deviate from the analytical solution by applying numerical procedures, for example on determination of the vibration shape. Besides, torsional stiffness can be determined by applying an iteration procedure. Above all these deviations from an analytical solution contribute to increasing accuracy. Besides, those deviations facilitate the universal applicability of the method.

The following basic explanations are presented for simple load-bearing masts or lamp masts as lamp, antennae, traffic sign or traffic light masts. The underlying principle is applicable to other mast types in the same manner.

The following tables give a survey of the most essential variables and parameters utilized.

| | | | |
|---|---|---|---|
| Geometry | Mast height above terrain top edge (GOK) | H | [m] |
| of a mast | Mast diameter at bottom | dᵤ | [m] |
| | Mast diameter at top | dₒ | [m] |
| | Taper | α | [—] |
| | Cross section at bottom | Aᵤ | [m²] |
| | Cross section at top | Aₒ | [m²] |
| | Moment of inertia at bottom | Iᵤ | [m⁴] |
| | Moment of inertia at top | Iₒ | [m⁴] |
| Mast | Mast type | A, T | [—] |
| | Type of wood | Meranty (KI) | [—] |
| | | Larch (LA) | |
| | Wood moisture (at sensor position and at bottom!), | fₕ | [%] |
| | additionally elevation of sensor above GOK required | | |
| | for executing the example | | |
| | Mast flexural stiffness | C_{B} | [N/m] |
| | Mast rotation stiffness | C_{φ} | [N/m] |
| | Overall stiffness | C_{Gesamt} | [N/m] |
| | Generalized mass due to flexure | M_{gen, Mast, Bleg} | [kg] |
| | Generalized mass due to torsion | M_{gen, Mast, Rot} | [kg] |
| | Generalized mass mixed portion | M_{gen, Mast, Mlsch} | [kg] |
| | Generalized mass in total | M_{gen, Mast, gesamt} | [kg] |
| Line with | Field length (distance to nearest mast on the left side) | L_{L} | [m] |
| Mast with | Field length (distance to the nearest mast on the right side) | L_{R} | [m] |
| Ropes | Number of ropes and/or Isolators | n | [—] |
| | Height of the lowest line | hₗ | [m] |
| | Line type | Steel-Alu, steel | [—] |
| | Line cross section | A_{L, u} | [m²] |
| | Line sagging (at left) | d_{L} | [m] |
| | Line sagging (at right) | d_{R} | [m] |
| | Line mass per length (at left) | ρ_{L} | [kg/m] |
| | Line mass per length (at right) | ρ_{R} | [kg/m] |
| | Line mass | M_{L} | [kg] |
| | Generalized mass of lines | M_{gen, Leitung, gesamt} | [kg] |
| | Isolator mass | M_{I} | [kg] |
| | Vertical distance of isolators | s | [m] |
| | (horizontal distance of isolators possibly required) | | |
| | Density conductor | ρ_{L} | [kg/m³] |
| | Rope factor | β | [—] |
| | E-module conductor | E_{L} | [kN/cm²] |
| | Horizontal force - force from rope | H | [N] |
| | Longitudinal stiffness of rope | EA/L | [N/m] |
| | (E-Module*cross section area/rope length) | | |
| | Stiffness vertically to conductor level CL | C_{L} | [N/m] |
| | for a single line | | |
| | Stiffness vertically to conductor level | C_{L, Gesamt} | [N/m] |
| | Stiffness in conductor level CLS | C_{LS} | [N/m] |
| Measurement | Temperature (on measuring date) | T | [C.] |
| | Measured natural frequency (on measuring date) | f_{gem} | [Hz] |
| | Height of load impact point of wire rope force above GOK | hₗ | [m] |
| | Lever arm of eccentricity of vertical load | h_{V} | [m] |
| | V relative to mast axis | | |
| Admissible | | | [—] |
| deformation | | | |
| | Admissible deformation for class 1 | d_{zul, 1} | [m] |
| | Admissible deformation for class 2 | d_{zul, 2} | [m] |
| | Admissible deformation for class 3 | d_{zul, 3} | [m] |

It is the target to determine the displacement of the mast tip in vertical direction versus the conductor level (if any) due to horizontal and vertical loads. To simplify the system, it is at first required to calculate the overall stiffness. There are at least three components, i.e.:
1. Mast flexural stiffness
2. Mast rotation stiffness
3. Conductor stiffness
4. (additionally guys or domestic connections etc.)

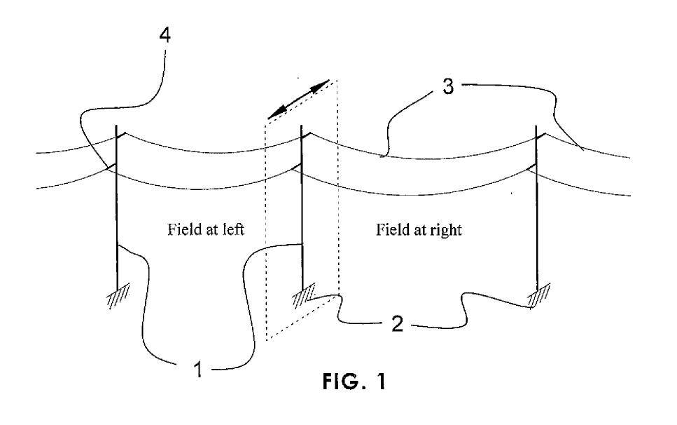

FIG. 1 shows a principle sketch with masts 1 which are anchored in the substrate 2. The masts carry the ropes and/or power conductors 3. The power conductors 3 are fastened by the aid of isolators 4 to the masts 1.

If there are guys, these are also taken into account. This is a special case which is not dealt with more closely in the following.

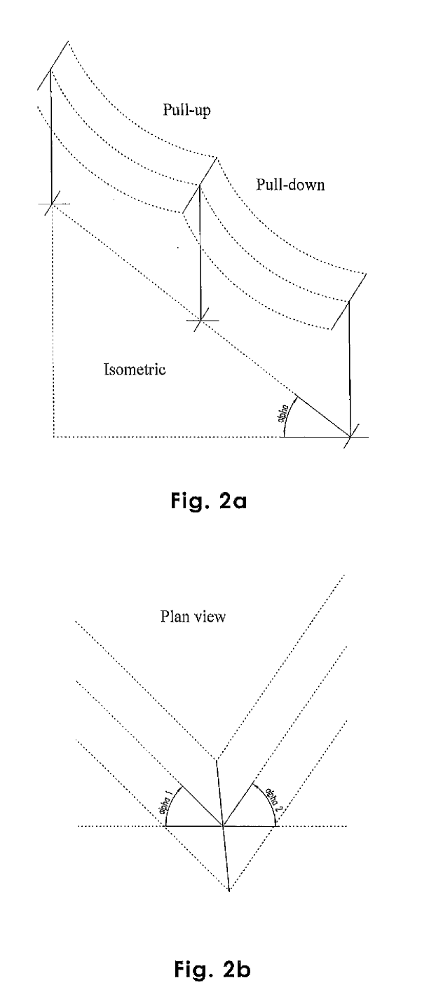

It is possible to assess masts that are strained by upward pull or downward pull. Furthermore, masts can be calculated which stand at kinks of conductor routes. The reset forces from the conductor ropes are accordingly adapted in the program to this effect. Thus the correct pertinent stiffnesses result from the ropes. FIGS. 2a and 2b schematically show the situations addressed, i.e. the geometry with upward pull or downward pull and with masts at kinks in conductor routes. However, the calculation of these stiffnesses is not outlined more closely in the following.

Moreover, stiffness depends on the properties of material. For wooden masts, the moisture of the material and the ambient temperature are additionally measured for this reason, because both parameters influence significant properties of the lumber.

Ambient temperature shall be measured on the day of taking the measurement in order to correctly record the stiffness of the wire rope attachments prevailing on the day of measurement. In a static calculation of the masts, it is also necessary to take account of the temperature at other ambient conditions. It influences the rope sagging and thus the reset forces due to the wire ropes. For systems without wire rope attachments, the temperature can usually be neglected.

Calculations of the overall stiffness and individual single portions are outlined in the following.

The influence of material moisture with wooden masts is addressed in the following. Material moisture influences both the E-module of wood and the admissible strains and stresses. Since the outer ring of the cross section (approx. 5 cm) is relevant for deformations and, if provided, for the static proof, moisture is preferably determined there only. Thus it is possible to utilize a measuring device which for example operates with ultrasonics and thus does not provoke any damage to the lumber. A driving-in or pressing-in of electrodes is therefore not required.

The measured lumber moisture is also utilized to determine the correct density of the material and thus of the mass, too.

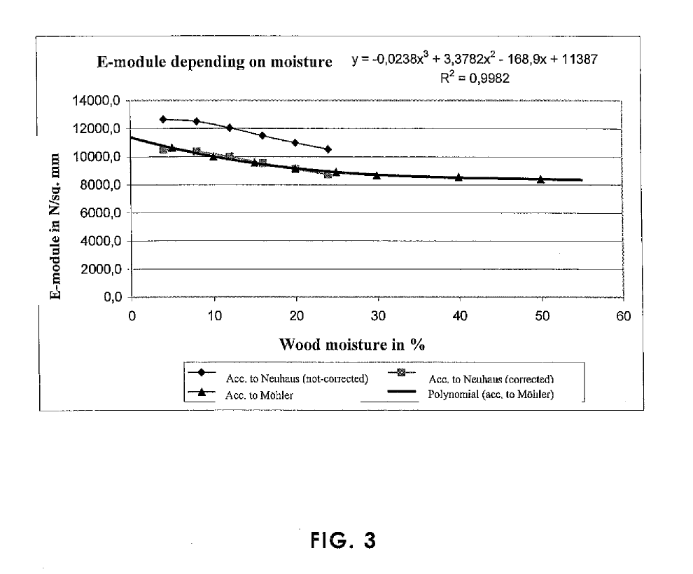

FIG. 3 shows the principle dependence of the E-module for lumber on the lumber moisture (for an E-module of approx. 10,000 N/mm² with 12% moisture according to various sources).

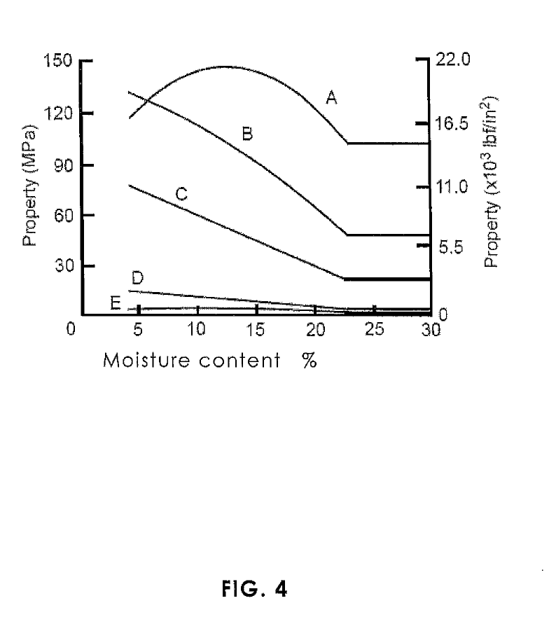

Similar kinds of dependence may be found, for example, in [12] (see FIG. 4). However, the dependence of flexural stiffness on moisture as indicated therein is greater. Own empirical values demonstrate that moisture in masts decreases as their age grows. A decreasing moisture, in turn, leads to a higher E-module and thus to a higher moisture. In one embodiment of the present invention, this effect is therefore advantageously compensated for, e.g. by an empirically determined age factor, that means advantageously even though the correction of the E-module pursuant to FIG. 3 underestimates the real growth of the E-module with a low moisture content.

If in the course of development, the E-module correction is adapted depending on moisture, the empirical age factor is therefore advantageously adapted, too.

FIG. 4 which is known from [12] (see FIG. 4-11) shows the dependence of various lumber properties on moisture. Curve A relates to the tension in parallel to the lumber grain, curve B relates to bending, curve C to compression in parallel to the lumber grain, curve D to compression perpendicular to the lumber grain, and curve E to the tension perpendicular to the lumber grain.

Lumber moisture is defined as follows:

$$u = \frac{{m}_{w}}{{m}_{0}} \cdot 100 = \frac{{m}_{u} - {m}_{0}}{{m}_{0}} \cdot 100 in \%$$

Where:
m_{w} water mass in kg
m₀ lumber mass with 0% moisture in kg
mᵤ lumber mass wet, with moisture u in kg

The real density of the lumber with a certain moisture u (in %) thus results as follows:

ρᵤ=ρₒ·(1+u/100) with a moisture of 0% (kiln-dry), or

ρᵤ=ρ₁₂·(1+u/100)/1,12 with a moisture of 12% (room climate)

Taking the density at 0% moisture and converting it to the room climate, one gets the following values for densities depending on lumber moisture for 4 different lumber types.

| | Density (0%) | Density (12%) |
|---|---|---|
| Wood type | kg/m³ | kg/m³ |
| Fir | 429 | 480.5 |
| Spruce | 411 | 460.3 |
| Pine | 465 | 520.8 |
| Larch | 527 | 590.2 |

The following table contains typical data from various sources for the E-module and density of various lumber types with a 12% moisture (see [6]).

Data for Moisture = 12%, T = 20°, Air Humidity 65%

| | Parallel | |
|---|---|---|
| | E-module (12%) | Density (12%) |
| Lumber type | N/mm² | kg/m³ |
| Fir | 10000 | 470 |
| Spruce | 10000 | 470 |
| Pine | 11000 | 520 |
| Larch | 12000 | 590 |

For stress analyses, the influence of moisture on mechanical properties (tensile and a compressive strength) is advantageously taken into account, too.

The influence exerted by ambient temperature is outlined below.

With a wire rope attachment that is tension-free, one may assume that the wire ropes have the same temperature as the environment. The temperature of the environment is therefore measured on the measuring day and assumed as the temperature of the wire ropes.

With a rope attachment under tension, the rope temperature theoretically correctly also results from the power charged in the wire ropes at the moment of taking the measurement. This temperature can be computed from data furnished by the power mains operator.

For the static proof, the temperature prevailing at the moment of taking the measurements is hence usually considered in order to be able to compute rope sagging at the relevant temperatures. The basis for this are the field lengths and rope sagging measured at the moment of taking the measurement.

For lumber masts, the temperature is advantageously taken into account, if required, to determine the lumber characteristics. Strictly speaking, the E-module and the admissible tensions also depend on temperature. With the variation of temperature realized here during the measurements, however, this influence is usually neglectible. Detailed data on the influence of moisture and temperature can be found, for example, in [12]. These may also be taken into account in one embodiment of the present invention.

The following table 4-16 taken from [12] elucidates the dependence of the E-module (MOE=Modulus of Elasticity) on temperature T.

TABLE 4-16
Percentage change in bending properties of lumber with change in temperature^{a}

| | Lumber | Moisture | ((P − P₇₀)/P₇₀)100 = A + BT + CT² | | | Temperature range | |
|---|---|---|---|---|---|---|---|
| Property | grade^{b} | content | A | B | C | Tₘᵢₙ | Tₘₐₓ |
| MOE | All | Green | 22.0350 | −0.4578 | 0 | 0 | 32 |
| | | Green | 13.1215 | −0.1793 | 0 | 32 | 150 |
| | | 12% | 7.8553 | −0.1108 | 0 | −15 | 150 |
| MOR | SS | Green | 34.13 | −0.937 | 0.0043 | −20 | 46 |
| | | Green | 0 | 0 | 0 | 46 | 100 |
| | | 12% | 0 | 0 | 0 | −20 | 100 |
| | No. 2 | Green | 56.89 | −1.562 | 0.0072 | −20 | 46 |
| | or less | Green | 0 | 0 | 0 | 46 | 100 |
| | | Dry | 0 | 0 | 0 | −20 | 100 |

^{a}For equation, P is property at temperature T in ° F.; P₇₀, property at 21° C. (70° F.).
^{b}SS is Select Structural.

Since the temperature influence is considered, conclusive findings and results are obtained even in case of very large differences in temperature.

The influence exerted by age is outlined below. For lumber, the age influences both the moisture in the material and the strength. Older masts evidence a substantially higher stiffness than young masts.

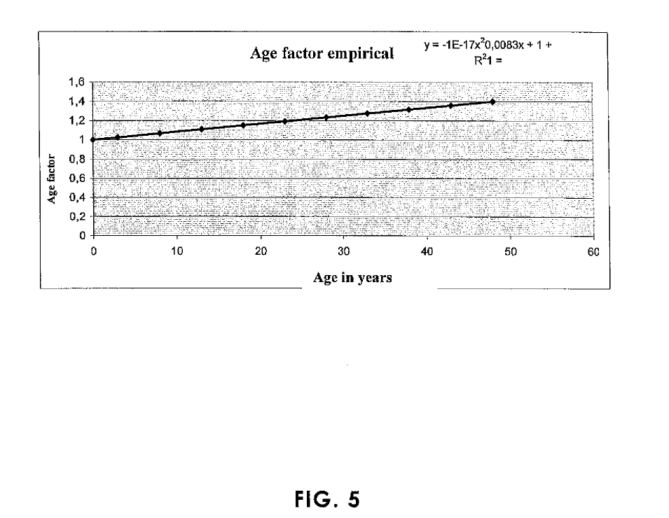

The influence exerted by age on stiffness has been empirically derived from the measuring data. By way of a growing number of measuring data, the influence of the age effect can be accentuated continuously. FIG. 5 shows an empirically determined influence which demonstrates the increase of the E-module depending on the age in years. The influence of this age factor is duly taken into account in the software by implementing the corrective function shown in FIG. 5,

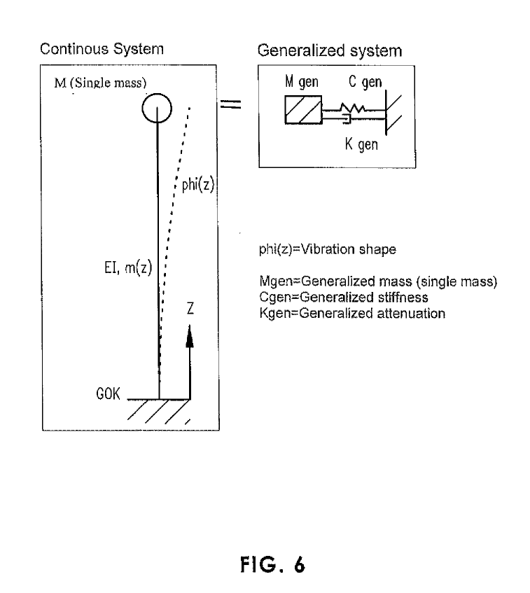

For the further analysis, the mast to be examined is initially transformed into a generalized system. This represents a common practice to transform a complex system comprised of numerous rods, knots, and masses into an equivalent single-mass oscillator. A single-mass oscillator has got the same dynamic properties as the complex original system. In particular, this relates to stiffness and to natural frequency of the system. Usually the virtual single-mass oscillator is positioned at the place of the maximal deformation of the underlying vibration pattern of the system. Here it is the mast tip. FIG. 6 elucidates the initial system and the generalized system.

An energy contemplation and the requirement on energy to be equal during an oscillation period for both systems results in the corresponding formulae to determine the characteristic variables of the generalized substitute system, which are:

M_{gen} generalized mass and
C_{gen} generalized stiffness

The formulae for determination of the generalized mass read as follows:

$$E = {\int }_{0}^{H} \frac{1}{2} \cdot m ( z ) \cdot {\dot{y}}^{2} ( z ) d z = \frac{1}{2} \cdot {M}_{gen } \cdot {\dot{y}}^{2} ( H )$$

$$\dot{y} ( z ) = y ( z ) \cdot {ω}_{e} = {y}_{max} \cdot φ ( z ) \cdot {ω}_{e}$$

Energy E is equal for both systems. Since the generalized system is mounted here at the place of the maximal modal deformation, the following equation applies:

\dot{y}(H)=y(H)·ωₑ=yₘₐₓ·φ(H)·ωₑ=yₘₐₓ·1,0·ωₑ

Then the generalized mass is as follows:

$${M}_{gen} = {\int }_{0}^{H} m ( z ) \cdot {φ}^{2} ( z ) d z$$

For example, assuming

$$φ ( z ) = {( \frac{z}{H} )}^{2}$$

for the oscillation pattern (parabolic curve), one gets at the following equation for M_{gen}:

$${M}_{gen} = {\int }_{0}^{H} m ( z ) \cdot {( \frac{z}{H} ) }^{4} d z$$

$$for m ( z ) = m = const . follows$$

$${M}_{gen } = m \cdot \frac{H}{5}$$

Natural frequency fₑ of the generalized system is:

$${f}_{e} = \frac{1}{2 π} \cdot \sqrt{\frac{{C}_{gen}}{{M}_{gen}}} = \frac{{ω}_{e}}{2 π}$$

The determination of M_{gen} is again specifically outlined further below for the individual components of the mast systems. The determination of C_{gen} here is realized via the measurement of natural frequency of the system. To this effect, the a.m. formula is re-arranged as follows:

C_{gen}=(2π·fₑ)²·M_{gen}=ωₑ²·M_{gen}

The generalized stiffness C_{gen} thus determined is the overall stiffness C_{Gesamt} of the system. For the further analysis, it is split up into its individual constituents.

Overall stiffness is composed of several individual constituents, i.e.:
1. Mast flexural stiffness C_{B}
2. Torsional stiffness of foundation C_{φ,B}, and
3. Stiffness of ropes C_{L,Gesamt}

These portions can be considered as springs which have to be combined to calculate overall stiffness. Accordingly, torsional stiffness and mast flexural stiffness shall be considered as a connection in series, whereas the conductor stiffness shall be additively taken into account as a connection in parallel. Overall stiffness can then be computed as follows:

$${C}_{Gesamt} = {C}_{L , Gesamt} + {( \frac{1}{{C}_{B}} + \frac{1}{{C}_{ϕ , B}} )}^{- 1}$$

For a full restraint, i.e. torsional stiffness is infinite, the following shall apply:

$${C}_{ϕ , B} = ∞ \text{===>} \frac{1}{{C}_{ϕ , B}} = 0$$

$${C}_{Gesamt} = {C}_{L , Gesamt} + {C}_{B}$$

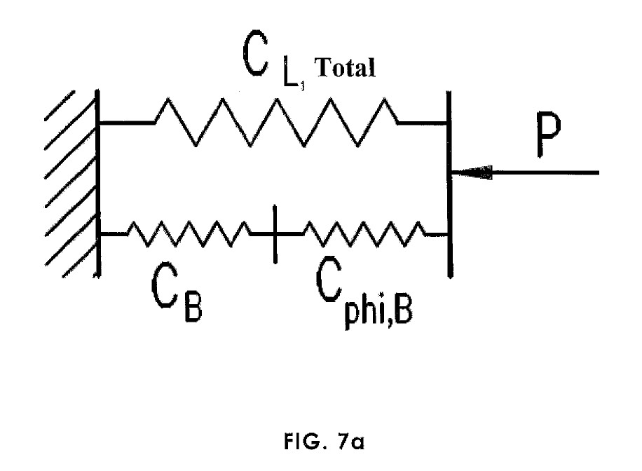

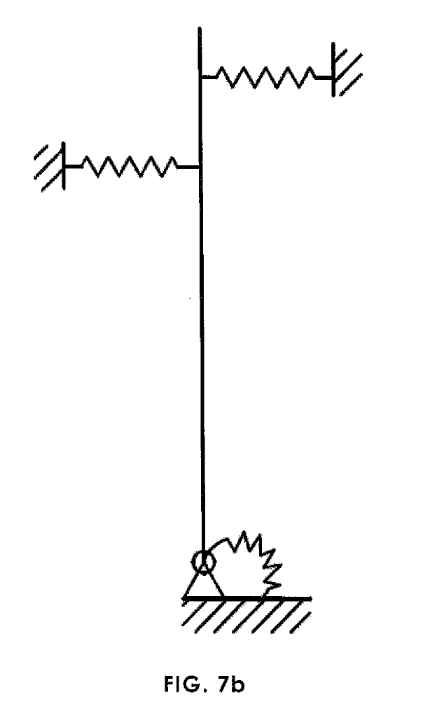

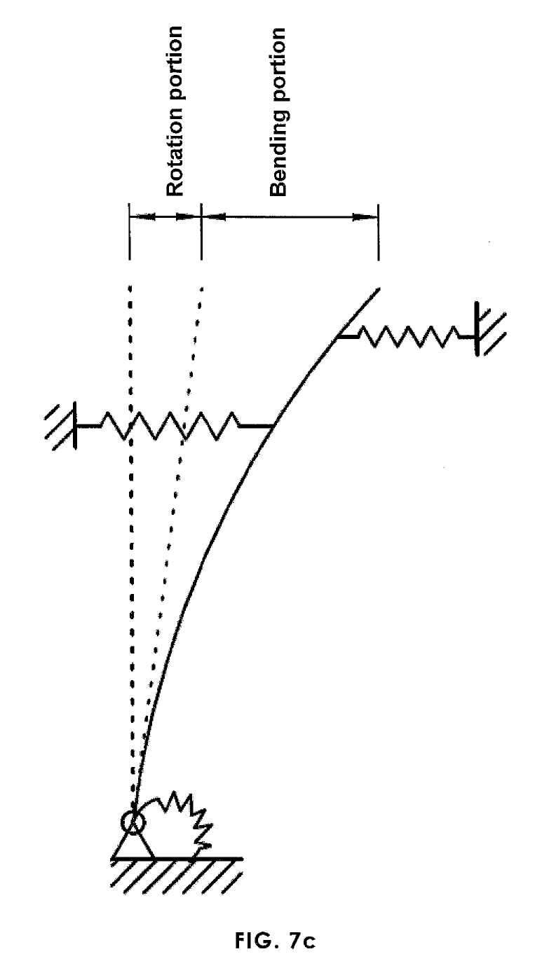

in FIGS. 7a to 7c, the deformation portions are schematically represented. Portions C_{B} and C_{L,Gesamt} are obtained purely analytically. Portion C_{φ,B} then represents the only unknown variable. Knowing the measured frequency, it can then be computed from the measuring result.

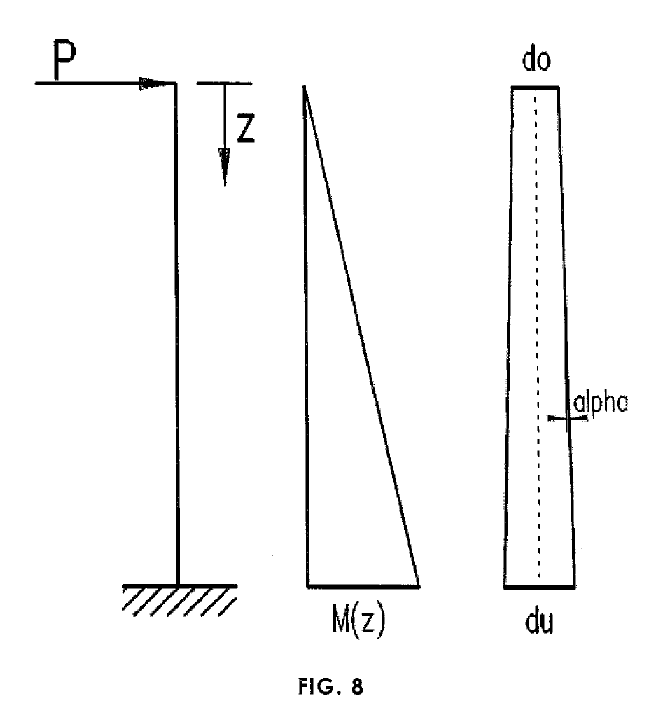

The Mast flexural stiffness is determined analytically. FIG. 8 elucidates the derivation for computation of the flexural stiffness C_{B} by way of example for a conical mast with circular-cylindrical solid cross section. The mast flexural stiffness is then computed as follows:

$$\begin{matrix}δ = {\int }_{0}^{H} \frac{M ( z ) m ( z )}{EI ( z )} d z \\ = {\int }_{0}^{H} \frac{{z}^{2}}{E \frac{π}{64} {( {d}_{o} - α z )}^{4}} d z \\ = \frac{64}{E π} {\int }_{{d}_{o}}^{{d}_{u}} \frac{- {( \frac{{d}_{o} - x}{α} )}^{2}}{{x}^{4}} \frac{d x}{α} \\ = - \frac{64}{{α}^{3} E π} {\int }_{{d}_{o}}^{{d}_{u}} \frac{{d}_{o}^{2} + {x}^{2} - 2 {d}_{o} x}{{x}^{4}} d x \\ = \frac{64}{{α}^{3} E π} [ - \frac{1}{3 {d}_{o}} + \frac{{d}_{o}^{2}}{3 {d}_{u}^{3}} + \frac{1}{3 {d}_{u}} - \frac{{d}_{o}}{{d}_{u}^{2}} ]\end{matrix}$$

$${d}_{o} - α z = x$$

$$dz = \frac{- dx}{α}$$

$$z = \frac{{d}_{o} - x}{α}$$

$$\begin{matrix}{C}_{B} = \frac{1}{δ} [ N / m ] \\ = {\frac{{α}^{3} E π}{64} [ - \frac{1}{3 {d}_{o}} + \frac{{d}_{o}^{2}}{3 {d}_{u}^{3}} + \frac{1}{3 {d}_{u}} - \frac{{d}_{o}}{{d}_{u}^{2}} ]}^{- 1}\end{matrix}$$

The flexural stiffness of a mast is merely derived from its geometry and mechanical properties. To be taken into account is the fact that the modulus of elasticity for lumber materials is determined depending on the moisture measured. This influence is duly considered via moisture measurements.

Recording of damaged cross section values can be precisely realized by a more precise measuring method. But to evaluate stability it is sufficient to allocate mast damages in their entirety to the torsion spring C_{φ} at the base which is still to be determined. All influences affecting the stiffness of the overall system are virtually allocated to the foundation. Deformations at the mast head then nevertheless result in the same magnitude as in a detailed split of damages to the mast shaft and to the foundation. This has been verified by relevant investigations and studies.

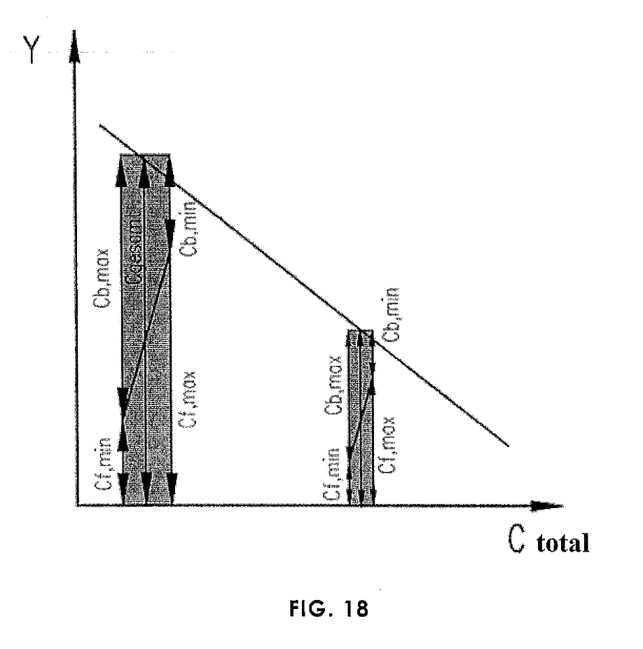

FIG. 18 shows that overall deformation practically remains the same independently of the distribution of stiffness portions among each other. Scatterings of material properties (e.g. with the E-module) therefore practically do not take any influence on the computed deformation at the head, because it is the determined overall stiffness that is decisive for it. For example, this implies the following: with an overestimation of the real E-module, a small torsion spring stiffness is arithmetically computed. With an underestimation of the E-module, it is vice versa. The relevant overall stiffness in both cases is roughly the same, so that the computed deformations remain within the same magnitude. The computed heat deformation is therefore especially suitable to serve as a criterion for assessing stability.

This analytical approach permits drawing conclusions with one mechanical measuring variable only and with the lumber moisture and ambient temperature as to the overall stiffness of the overall system.

The torsion spring stiffness of the foundation

C_{φ}

is further elucidated and addressed in the following.

Torsion spring stiffness is transformed into an equivalent horizontal substitute spring. Hereby, it is easier to be taken into account in the generalized system. The stiffness of this spring which is mounted at the elevation of the generalized system can be computed as follows (conversion of torsion spring stiffness into an equivalent horizontal substitute spring):

$${C}_{ϕ} \text{:} Torsional spring bottom [ \frac{N}{rad} ]$$

$${C}_{ϕ , B} \text{:} Eq . flexural stiffness [ \frac{N}{m} ]$$

$$\frac{PH}{{C}_{ϕ}} H = \frac{P}{{C}_{ϕ , B}}$$

$${C}_{ϕ , B} = \frac{{C}_{ϕ}}{{H}^{2}}$$

The torsion spring should represent the foundation stiffness and possibly existing damages of the mast. Since stability is eventually computed by calculating the maximal deformation under quasi-static loads, the dynamic measurements are so realized that the dynamic E-module of the soil is not activated. It means the excitated oscillation amplitudes have to be kept at a low level.

This should be seen against the background that depending on the soil type the dynamic E-module may be greater by a factor of 2 to 4 (partly even more) than the static E-module of the soil.

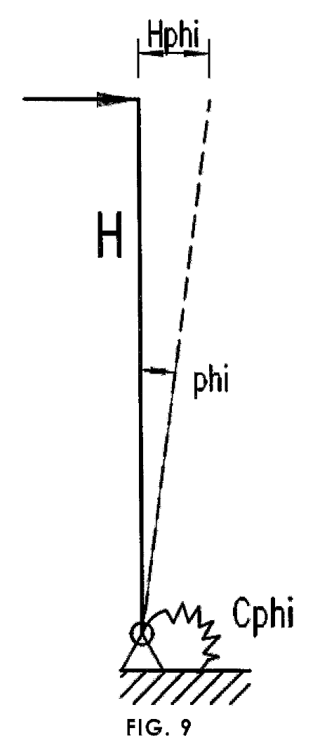

FIG. 9 schematically shows the static system for conversion of virtual torsion spring stiffness into on equivalent horizontal substitute spring. Now, if just contemplating the horizontal displacement portion from the torsion spring, a displacement of H*phi results at the mast head (in principle the mast length multiplied by the twisting angle).

The conductor stiffness (C_{L}) is further elucidated and dealt with in the following (C_{L}). To determine the entire line stiffness, the stiffness for a single line in vertical direction to the conductor level is computed at first. Accordingly, various lengths of the ropes in the field at right and at left are taken into account. Subsequently, the individual stiffnesses are summarized to a generalized overall stiffness. The generalized system is virtually positioned at the place of the maximal modal deformation δ_{G}.

The conductor stiffnesses from the field at right and at left (viewed from the mast) are computed as follows.

$${C}_{L} = \frac{{ρ}_{L} {A}_{L} {gL}_{L}}{8 {d}_{L}} + \frac{{ρ}_{R} {A}_{R} {gL}_{R}}{8 {d}_{R}}$$

$${C}_{L , Gesamt} = {\sum }_{i} {α}_{i}^{2} {C}_{{L}_{i}}$$

$$\{ \begin{matrix}{α}_{i} = \frac{{δ}_{i}}{{δ}_{G}} \\ {δ}_{G} = max ( {δ}_{i} ) = 1 ( Standardized modal deformation )\end{matrix} \\ {Z}_{i}^{*} = \frac{{z}_{i}}{H} ( standardized height ) \\ {δ}_{i} = {Z}_{i}^{* 2} \frac{{C}_{ϕ , B}}{{C}_{B} + {C}_{ϕ , B}} + {Z}_{i}^{*} \frac{{C}_{B}}{{C}_{B} + {C}_{ϕ , B}} \\ \begin{matrix}{C}_{L , Gesamt} = {\sum }_{i} [ {( {Z}_{i}^{* 2} \frac{{C}_{ϕ , B}}{{C}_{B} + {C}_{ϕ , B}} + {Z}_{i}^{*} \frac{{C}_{B}}{{C}_{B} + {C}_{ϕ , B}} )}^{2} {C}_{{L}_{i}} ] \\ = \frac{{C}_{L}}{{( {C}_{B} + {C}_{ϕ , B} )}^{2}} ( \begin{matrix}{C}_{ϕ , B}^{2} {\sum }_{i} {Z}_{i}^{* 4} + \\ 2 {C}_{B} {C}_{ϕ , B} {\sum }_{i} {Z}_{i}^{* 3} + {C}_{B}^{2} {\sum }_{i} {Z}_{i}^{* 2}\end{matrix} )\end{matrix} \\ Assumption \text{:} {C}_{{L}_{i}} = {C}_{{L}_{j}} i \neq j$$

The conductor stiffnesses for the field at right and at left are considered simultaneously.

The computation of the modal deformation δᵢ results from the connection in series of the springs C_{B} and C_{φ,B}. Since the conductor ropes usually are not positioned at the mast tip, the correct modal deformation δᵢ is also obtained by contemplating the energy. This leads to the pre-factors Zᵢ^{*2} with the torsion spring portion and Zᵢ* with the bending portion.

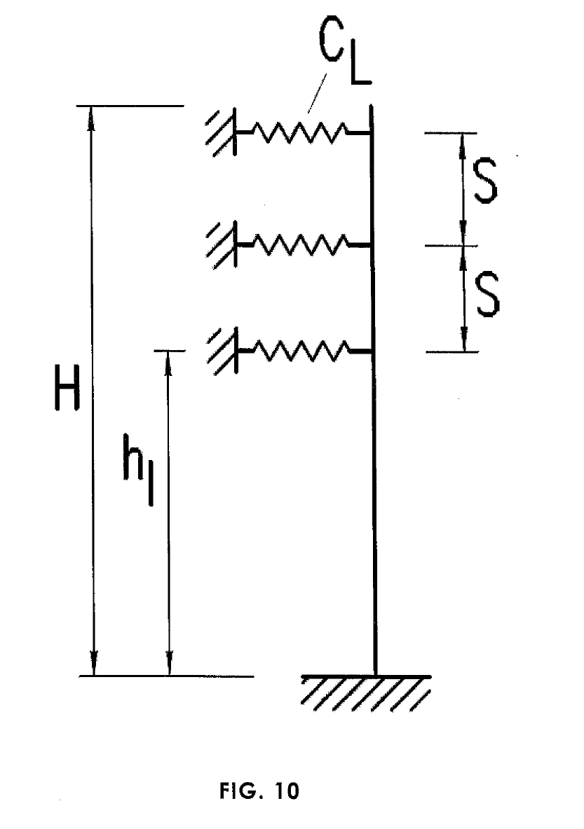

FIG. 10 schematically shows the system for computing the conductor stiffness. The height hr in FIG. 10 corresponds to the height z₁ in the a.m. formula. The heights of the two other ropes z₂ and z₃ are not indicated in FIG. 10.

Taking the formulae previously developed, an equation for C_{Gesamt} can be set up in which only the torsion spring portion is unknown. Stiffness C_{Gesamt} results from the measured frequency and from the generalized mass.

In the following, the generalized mass is further explained and dealt with.

The generalized mass is composed of the portions of the masses participating in the oscillation, mast masses, line masses, isolator masses and additional masses. Depending on where the masses are positioned in the system, they participate more or less in the oscillation. This is recorded through the relevant oscillation pattern contemplated in each case.

In the following, the shape and/or pattern of the oscillation and/or vibration as well as the generalized mass for the mast are further elucidated and outlined.

Here the oscillation pattern is composed of two portions. It is one portion composed of the mere bending of the mast shaft and a torsional portion composed of the torsion and/or twisting in the foundation. An additional mixed portion is created on derivation by coupling these portions. Hence the oscillation pattern to be assumed for calculating the generalized mass eventually has got three components:
1. Flexure portion
2. Torsion portion
3. And mixed portions

The generalized mass also results from contemplating the energy for the oscillating complex system and the simplified generalized system. The following scheme exemplary shows the calculation of the generalized mass for the mast shaft of a conical mast with circular-cylindrical solid cross section. Parameter y(z) represents the standardized oscillation pattern to be assumed (here assumed as a parabolic pattern y(z)=(z/H)²), which takes value 1.0 at the place of the maximal deformation.

The generalized mass for a conical mast with a circular-cylindrical solid cross section is computed as follows:

$${M}_{Gen , M} = \int M ( z ) {y ( z )}^{2} d z$$

$$M ( z ) = ρ A ( z ) = ρ \frac{π}{4} {d ( z )}^{2} = ρ \frac{π}{4} {( {d}_{u} + α z )}^{2}$$

$$y ( z ) = {( \frac{z}{H} )}^{2} \frac{{C}_{ϕ , B}}{{C}_{B} + {C}_{ϕ , B}} + ( \frac{z}{H} ) \frac{{C}_{B}}{{C}_{B} + {C}_{ϕ , B}}$$

$$\begin{matrix}{M}_{Gen} = \frac{π ρ}{4} {\int }_{0}^{H} ρ \frac{π}{4} {{( {d}_{u} + α z )}^{2} [ \begin{matrix}{( \frac{z}{H} )}^{2} \frac{{C}_{ϕ , B}}{{C}_{B} + {C}_{ϕ , B}} + \\ ( \frac{z}{H} ) \frac{{C}_{B}}{{C}_{B} + {C}_{ϕ , B}}\end{matrix} ]}^{2} d z \\ = \frac{πρ}{4} ( \begin{matrix}\frac{{d}_{u}^{2} {C}_{ϕ , β}^{2}}{5} H + \frac{{d}_{u}^{2} {C}_{ϕ , β}}{2} H + \frac{{d}_{u}^{2} {C}_{B}^{2}}{3} H + \\ \frac{{d}_{u} α {C}_{ϕ , β}^{2}}{3} {H}^{2} + \frac{4 {d}_{u} α {C}_{B} {C}_{ϕ , β}}{5} {H}^{2} + \frac{{d}_{u} α {C}_{B}^{2}}{2} {H}^{2} + \\ \frac{{α}^{2} {C}_{ϕ , β}^{2}}{7} {H}^{3} + \frac{{α}^{2} {C}_{B} {C}_{ϕ , B}}{3} {H}^{3} + \frac{{α}^{2} {C}_{B}^{2}}{5} {H}^{3}\end{matrix} )\end{matrix}$$

In addition to the generalized masses due to translatory displacements and/or shifts, the rotation masses (natural moments of inertia and Steiner portions) with widely cantilevered components are taken into account. Masses with a large eccentricity (e.g. isolators at wide span spreaders in medium voltage range) may significantly influence the result and are therefore advantageously considered.

Furthermore, in addition to the portion of the mast itself, the co-oscillating masses of built-on attachments such as for example: conductor ropes, isolators, and other masses (e.g. traffic signs) are taken into account.

The oscillation pattern applied takes a noticeable influence on the computational results. Comparative computations have evidenced that congruence with theoretical values is improved, the more precise the oscillation pattern is described. If the oscillation pattern is congruent with the real oscillation pattern, then there is a nearly 100% congruence between theoretical displacement and/or deflection and computed displacement and/or deflection. For this reason, the oscillation pattern of the flexural portion in one embodiment is advantageously not pre-defined, but computed specifically, depending on the mast characteristics (geometry, cross section values, material properties, additional masses, etc.). This can be realized as follows.

In addition, the generalized mass for the conductor ropes is contemplated. The generalized mass of conductor ropes is derived from the pro rata rope mass from the left and right field (half the rope mass each in the relevant field) and from the modal displacement zᵢ* at the impact point of the mass.

$$\begin{matrix}{M}_{Gen , L} = {\sum }_{i} {M}_{{L}_{i}} {z}_{i}^{* 2} \\ = \frac{{M}_{L}}{{( {C}_{ϕ , B} + {C}_{B} )}^{2}} ( {C}_{ϕ , B}^{2} {\sum }_{i} {z}_{i}^{* 4} + 2 {C}_{B} {\sum }_{i} {z}_{i}^{* 3} + {C}_{B}^{2} {\sum }_{i} {z}_{i}^{* 2} )\end{matrix}$$

$$Assumption \text{:} {M}_{{L}_{i}} = {M}_{{L}_{j}} i \neq j$$

The generalized mass of conductor ropes itself is obtained by assuming a linearly variable displacement. It means it is assumed that only the excitated mast will move while the adjacent masts stay calm. Moreover, natural movements of the rope are neglected. Then the generalized mass of the conductor ropes is as follows:

$${M}_{L , gen} = {\int }_{0}^{L} {m}_{L} \cdot {( \frac{z}{H} )}^{2} d z = {m}_{L} \cdot \frac{L}{3}$$

The generalized masses of wire ropes from the left and right field are superposed, and thus it results the following:

$${M}_{L , gen} = {m}_{L , left} \cdot \frac{{L}_{left}}{3} + {m}_{L , right} \cdot \frac{{L}_{right}}{3}$$

Length L is the rope length between two masts. It is greater than the distance of the mast in the field (slightly longer <1%).

Contemplated in the following is the generalized mass for the isolators. The generalized mass of isolators results from the isolator mass and from the modal displacement zᵢ* at the position of the isolator:

$$\begin{matrix}{M}_{Gen , I} = {\sum }_{i} {M}_{{I}_{i}} {z}_{i}^{* 2} \\ = \frac{{M}_{I}}{{( {C}_{ϕ , B} + {C}_{B} )}^{2}} ( {C}_{ϕ , B}^{2} {\sum }_{i} {z}_{i}^{* 4} + 2 {C}_{B} {\sum }_{i} {z}_{i}^{* 3} + {C}_{B}^{2} {\sum }_{i} {z}_{i}^{* 2} )\end{matrix}$$

$$Assumptions \text{:} {M}_{{I}_{i}} = {M}_{{I}_{j}} i \neq j$$

$$The line and the pertinent isolator are both located at the same elevation .$$

The generalized masses for additional masses are contemplated in the following. The generalized mass of additional masses is derived from the relevant mass and from the modal displacement zᵢ* at the position of the additional mass:

$$\begin{matrix}{M}_{Gen , Z} = {\sum }_{i} {M}_{{Z}_{i}} {z}_{i}^{′ * 2} \\ = \frac{{M}_{Z}}{{( {C}_{ϕ , B} + {C}_{B} )}^{2}} ( {C}_{ϕ , B}^{2} {\sum }_{i} {z}_{i}^{′ * 4} + 2 {C}_{B} {\sum }_{i} {z}_{i}^{′ * 3} + {C}_{B}^{2} {\sum }_{i} {z}_{i}^{′ * 2} )\end{matrix}$$

The analytical determination of torsional spring stiffness is dealt with and addressed further below. Torsional spring stiffness can be analytically determined with the formulae described hereinabove. The corresponding development of the apparatus of formulae is outlined below.

$$\{ \begin{matrix}\begin{matrix}{M}_{Gen , Gesamt} = {G}_{L , Gesame} {ω}^{- 2} \\ = [ {C}_{L , Gesamt} + {( \frac{1}{{C}_{B}} + \frac{1}{{C}_{ϕ , B}} )}^{- 1} ] {ω}^{- 2} \\ = \frac{{C}_{L , Gesamt} {C}_{B} + {C}_{L , Gesamt} {C}_{ϕ , B} + {C}_{B} {C}_{ϕ , B}}{{C}_{B} + {C}_{ϕ , B}} {ω}^{- 2} \text{===>}\end{matrix} \\ {M}_{Gen , Gesamt} = {M}_{Gen , M} + {M}_{Gen , L} + {M}_{Gen , I} + {M}_{Gen , z}\end{matrix} \\ [ \frac{πρ}{4} ( \frac{{d}_{u}^{2}}{5} H + \frac{{d}_{u} α}{3} {H}^{2} + \frac{{α}^{2}}{7} {H}^{3} ) + ( {M}_{L} + {M}_{I} ) {\sum }_{i} {z}_{i}^{* 4} + {M}_{z} {\sum }_{j} {z}_{j}^{′4} ] {C}_{ϕ , B}^{2} + [ \frac{πρ}{4} ( \frac{{d}_{u}^{2}}{2} H + \frac{4 {d}_{u} α}{5} {H}^{2} + \frac{{α}^{2}}{3} {H}^{3} ) + ( {M}_{L} + {M}_{j} ) {\sum }_{i} {z}_{i}^{* 3} + {M}_{z} {\sum }_{j} {z}_{j}^{′3} ] {C}_{B} {C}_{ϕ , B} + [ \frac{πρ}{4} ( \frac{{d}_{u}^{2}}{3} H + \frac{{d}_{u} α}{2} {H}^{2} + \frac{{α}^{2}}{5} {H}^{3} ) + ( {M}_{L} + {M}_{I} ) {\sum }_{i} {z}_{i}^{* 2} + {M}_{z} {\sum }_{j} {z}_{j}^{′ * 2} ] {C}_{b}^{2} = \begin{matrix}\frac{1}{{ω}^{2}} [ \begin{matrix}( {C}_{L , Gesmant} {\sum }_{i} {z}_{i}^{* 4} + {C}_{B} ) {C}_{ϕ , B}^{2} + \\ \begin{matrix}( 2 {C}_{L , Gesmant} {\sum }_{i} {z}_{i}^{* 3} + {C}_{B} ) {C}_{B} {C}_{ϕ , B} + \\ {C}_{B}^{2} {C}_{L , Gesmant} {\sum }_{j} {z}_{j}^{* 2}\end{matrix}\end{matrix} ] & ( Torsion portion ) \\ ( {A}_{1} - {A}_{2} ) {C}_{ϕ , B}^{2} + ( {B}_{1} - {B}_{2} ) {C}_{ϕ , B} + ( {C}_{1} - {C}_{2} ) = 0 & ( Mixed portion ) \\ {C}_{ϕ , B} = \frac{- B \pm \sqrt{{B}^{2} - 4 AC}}{2 A} & ( Flexural portion )\end{matrix}$$

A static substitute system can be defined by the aid of these results. Displacements due to vertical and horizontal loads are then computed in this system.

The determination of torsional spring stiffness and/or the relationship between torsional spring stiffness and flexural stiffness is advantageously done by applying an iteration method. As compared with an analytical solution, this method bears a huge advantage as it is more universal. Adaptations due to other system properties thus need not be implemented in the analytical solution. The results of the iteration method and analytical method for the case outlined hereinabove are identical to each other.

Horizontal loads are mainly wind loads on the system, while vertical loads are manloads and/or erection loads. The magnitude of these loads is derived from the applicable codes and rules.

The evaluation of masts is dealt with in the following. The evaluation of the stability of masts is realized via deformation criteria which may vary depending on the system. Deformations and/or deflections are computed on the static substitute system with the stiffness values determined through measurements.

Loads to be assumed result from the applicable codes and rules,

Computed deformations are compared with the admissible deformations. Thus the masts can be classified into various classes.

The criteria stipulated in EN 40 are utilized for steel masts. It defines the following limit values for deformations under characteristic loads:

### Deformation Criteria for Metal Masts

Class 1: admissible d=4%*(H+w)
Class 2: admissible d=6%*(H+w)
Class 3: admissible d=10%*(H+w)

Wherein w is the horizontal deflection, Here it can be set to 0.

Deformations beyond class 3 are inadmissible.

For overhead line masts made of lumber, criteria in conformity with EN 40 have been developed. On account of the electrically live wire rope attachments and due to the requirement for bending stiffness, the criteria are more stringent than they are for metal masts.

### Deformation Criteria for Lumber Masts

Class 1: admissible d=1.5%*H
Class 2: admissible d=3.0%*H
Class 3: admissible d=5.0%*H

For example, the resultant consequences of the relevant classification are as follows.

### Consequences of the Classification for Lumber Masts

Class 1: without restriction;
Class 2: no more climbable, but still stable;
Class 3: not climbable, conditionally stable, must be exchanged within 3 months;
>Class 4: no more stable, must be replaced instantly.

Load cases are contemplated in the following.

The following load cases are investigated:
1. Wind as a load introduction onto the mast, conductor ropes, and built-on attachments
2. Wind on iced conductor ropes+wind onto the mast and built-on attachments
3. Erection load (manload)

Addressed in the following will be the wind load exerted onto the mast, conductor ropes, and built-on attachments:

Wind loads are determined, e.g. in conformity with VDE 210. In principle, the computation of wind loads can be adapted to all codes and rules to be considered. Accordingly, the reference wind speeds v_{ref} are taken into account depending on the location. The necessary data are taken from the relevant wind zone maps (e.g, DIN 1055-4 neu [4], VDE 210[3].

Wind loads onto the mast are derived as follows:

w_{M}=1,1·q(z_{H})·c_{M}·A_{M}

The aerodynamic coefficient cm depends on the cross section shape. For circular-cylindrical cross sections a coefficient c_{M}=0.7-0.8 is applied. The exact value is determined depending on the Reynolds number.

Wind loads onto the ropes are computed as follows:

w_{S}=q(z_{S})·c_{S}·A_{S}

Built-on attachments are taken into account, if they evidence significant load introduction areas (e.g. traffic signs). Components with a small-sized area such as isolators are preferably neglected. Loads on built-on attachments are considered as follows:

w_{A}=q(z_{A})·c_{A}·A

Accordingly, q(z_{A}) is the velocity compression at the elevation of the built-on attachment (point of gravity is decisive). c_{A} is the aerodynamic force coefficient. For built-on attachments, it is taken into account with c_{A}=2.0. It is considered depending on the aerodynamic shape of the built-on attachment. A is the load introduction area. The following cross sections are preferably provided for:

Wind on iced conductor ropes+wind onto the mast and built-on attachments:

For wind on iced wire ropes, the enhanced cross section area of the ropes is taken into account. The velocity compression is diminished at the same time, for example to 0.7q.

### Erection Load (Manload):

It is supposed that one man including equipment weighing 100 kg ascends the mast. The out-of-center is 0.3-0.5 m.

In the following, a displacement and/or deflection of the contemplated mast due to a horizontal load is shown and illustrated.

Horizontal loads for overhead line masts mainly result from wind loads impacting on the conductor ropes. The following scheme shows the computation of displacements due to wind load onto the conductor ropes. Accordingly, the portions due to mast bending and torsion are determined separately.

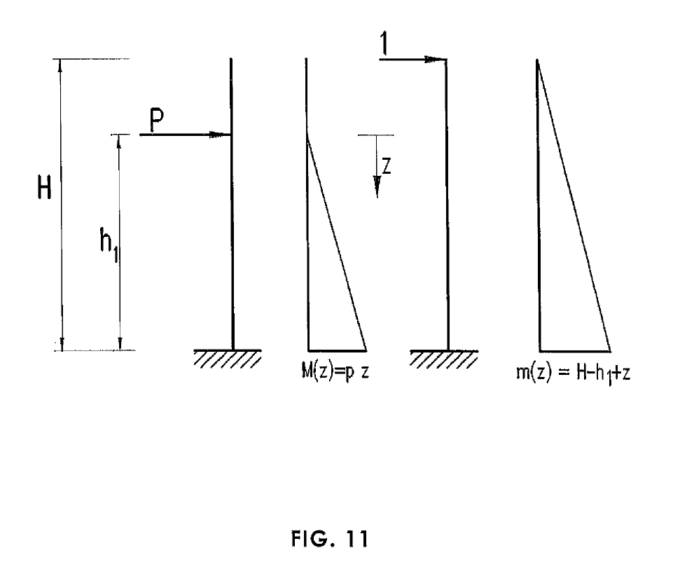

FIG. 11 schematically shows the static system for computing the head deformation when assuming a horizontal load at a certain elevation h₁ (bending portion only). The static computation method to determine the displacement at the mast head is based on the principle of “virtual forces”,

$$\begin{matrix}{δ}_{Bending} = {\int }_{0}^{{h}_{1}} \frac{M ( z ) m ( z )}{EI ( z )} d z \\ = {\int }_{0}^{{h}_{1}} \frac{p z ( H - {h}_{1} + z )}{E {\frac{π}{64} [ {d}_{o} - α ( H - {h}_{1} + z ) ]}^{4}} d z \\ = \frac{64 p}{E π} {\int }_{{d}_{o} - α ( H - {h}_{1} )}^{{d}_{u}} \frac{( \frac{{d}_{o} - x}{α} - H + {h}_{1} ) \frac{{d}_{o} - x}{α}}{{x}^{4}} \frac{- d x}{α} \\ = - \frac{64}{E π {α}^{3}} {\int }_{{d}_{o} - α ( H - {h}_{1} )}^{{d}_{u}} \frac{( {d}_{o} - x - H α + {h}_{1} ) ( {d}_{o} - x )}{{x}^{4}} d x \\ = {\frac{64}{E {πα}^{3}} [ \begin{matrix}( {d}_{o}^{2} - H {d}_{o} α + {h}_{1} {d}_{o} α ) \frac{1}{3 {x}^{3}} + \\ ( - 2 {d}_{o} + H α - {h}_{1} α ) \frac{1}{2 {x}^{2}} - \frac{1}{x}\end{matrix} ]}_{{d}_{o} - α ( H - {h}_{1} )}^{{d}_{u}}\end{matrix}$$

$${δ}_{Torsion} = \frac{M}{{C}_{ϕ}} H = \frac{p {h}_{1} H}{{C}_{ϕ}} = \frac{p {h}_{1} H}{{C}_{ϕ , B} {H}^{2}} = \frac{p {h}_{1}}{{C}_{ϕ , B} H}$$

$${d}_{o} - α ( H - {h}_{1} + z ) = x$$

$$dz = \frac{- dx}{α} \\ z = \frac{{d}_{o} - x}{α} - H + {h}_{1}$$

In the same manner, the wind loads on the mast itself or the wind loads on other built-on attachments (e.g. traffic signs) are taken into account. Hence the computation is generally applicable. In this form, it can in particular be utilized for all masts without conductor ropes.

The computation of the displacement and/or deflection of the mast contemplated due to a vertical load is outlined in the following. Vertical loads result from manloads and from other erection loads. The computation of displacements is described below. Accordingly, the portion from mast bending and mast torsion are again determined separately.

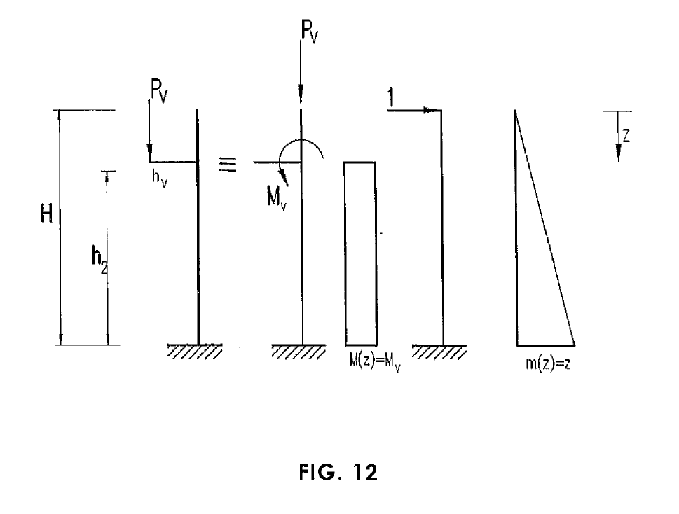

FIG. 12 shows a schematic representation of the static system for computing the head deformation when assuming a vertical load with an out-of-center hv. This vertical load causes a moment Mv, which at the mast head leads to a horizontal displacement. The static computation method for determining the displacement at the mast head is based on the principle of “virtual forces”.

$$\begin{matrix}{δ}_{Bending} = {\int }_{0}^{{h}_{1}} \frac{{M}_{V} z}{EI ( z )} d z \\ = {\int }_{0}^{{h}_{2}} \frac{{p}_{V} {h}_{V} z}{E {\frac{π}{64} [ {d}_{o} - α z )}^{4}} d z \\ = \frac{64 {M}_{V}}{E π} {\int }_{{d}_{o}}^{{d}_{u}} \frac{z}{{( {d}_{o} - α z )}^{4}} \frac{- d x}{α} \\ = - {\frac{64 {M}_{V}}{E π {α}^{2}} [ - \frac{1}{2 x} + \frac{{d}_{o}}{3 {x}^{3}} ]}_{{d}_{o}}^{{d}_{u}}\end{matrix}$$

$${δ}_{Torsion} = \frac{{M}_{V}}{{C}_{ϕ}} H = \frac{{p}_{V} {h}_{V} H}{{C}_{ϕ}} = \frac{{p}_{V} {h}_{V} H}{{C}_{ϕ , B} {H}^{2}} = \frac{{p}_{V} {h}_{V}}{{C}_{ϕ , B} H}$$

$${d}_{o} - α z = x$$

$$dz = \frac{- dx}{α} \\ z = \frac{{d}_{o} - x}{α}$$

Two masts are investigated and studied in the following, i.e. one mast having a hollow cross section and one mast having a solid cross section. The findings and results are compared with the results derived from a numerical model based on finite elements.

1. Steel mast with circular-ring cross section

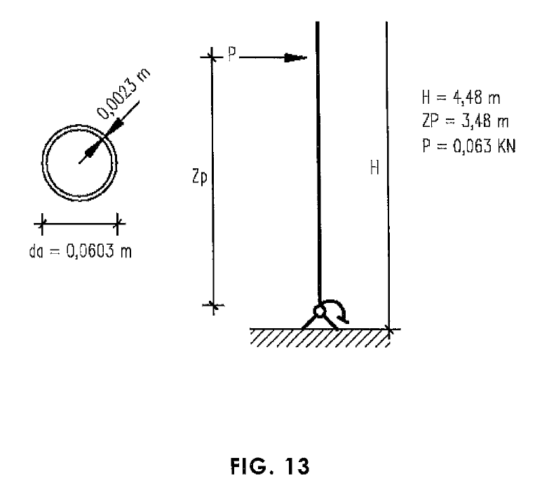

The steel mast is 4.48 m tall and it has a shell thickness of 2.3 mm. The properties of material and most are indicated in the following two tables titled “Material Properties” and “Mast Properties”, respectively. In case of a numerical simulation with the commercially available SAP2000 software program, a torsional spring stiffness is furthermore defined. The first natural frequency of the system computed by applying the commercially available SAP2000 software program is utilized as input for the outlined inventive computations and/or numerical calculations. FIG. 13 sketches the geometry of the contemplated steel mast with a circular-ring cross section.

### Material Properties:

| Density [to/m³] | E-Modules [kN/m²] |
|---|---|
| 7.846 | 2.1*10⁸ |

### Mast Properties:

| Frequency | Mass | Diameter | Taper |
|---|---|---|---|
| [Hz] | [to] | [m] | [—] |
| 2.67 | 0.0144 | 0.0603 | 0.0 |

At an elevation of 3.48 m, a horizontal load is introduced, and the displacement is computed at this elevation. The computation of the displacement is realized both in the software program SAP2000 and by applying a second program “MaSTaP”, which executes the computations outlined before. 0 shows a comparison of the results. Accordingly, two different oscillation patterns have been assumed for the bending portion in the second software program. (parabolic and sinusoidal).

The following table shows a comparison of findings and results:

| | Horizontal | Torsion | Frequency with |
|---|---|---|---|
| | Displacement | Spring Stiffness | full Restraint |
| | [m] | [kN/m] | [Hz] |
| SAP2000 | 0.0315 | 100.00 | 3.1 |
| MaSTaP* | 0.0334 | 80.437 | 3.2 |
| Discrepancy | 5.7% | 19.5% | 3.1% |
| MaSTaP** | 0.0362 | 62.156 | 3.4 |
| Discrepancy | 14.8% | 37.8% | 8.8% |

*Own bending shape with sinusoidal outset
**Own bending shape with parabolic outset

For the case chosen here, the results with the sinusoidal outset demonstrate better congruence with the theoretical result (SAP2000). The discrepancy with the horizontal displacement which is decisive for the evaluation merely amounts to 5.7%. Since the displacement is a bit overestimated, the result still lies on the safe side. Again the result demonstrates the influence of the assumed oscillation pattern on the result. If the oscillation pattern in the software program, which was called “MaSTaP”, is congruent with the real oscillation pattern, the congruence is nearly 100%. For this reason, the oscillation pattern of the bending portion is advantageously not defined, but computed specifically depending on the mast characteristics (geometry, cross section values, material properties, additional masses etc.).

The following table indicates further results obtained from the MaSTap software program. Indicated are the stiffness portions for bending and rotation, the overall stiffness for the generalized system at the mast head as well as the deformation portions.

| | Stiffness | Stiffness | Total | Def_bieg | Def_Rot | |
|---|---|---|---|---|---|---|
| | Due to bending | Due to rotation * | Stiffness | Height zp | Height zp | gen_masse |
| | [kN/m] | [kN/m] | [kN/m] | [m] | [m] | [to] |
| ¹ | 1.3233 | 4.1929 | 1.0059 | 0.0239 | 0.0094 | 0.0036 |
| ² | 1.3233 | 3.2399 | 0.93957 | 0.0239 | 0.0122 | 0.0033 |

¹ Own bending shape with sinusoidal outset
² Own bending shape with parabolic outset
* Equivalent stiffness at elevation H due to elastic restraint.

The displacement for the assumption of a sinusoidal oscillation pattern at elevation H results at 72% from bending at 28% from rotation.

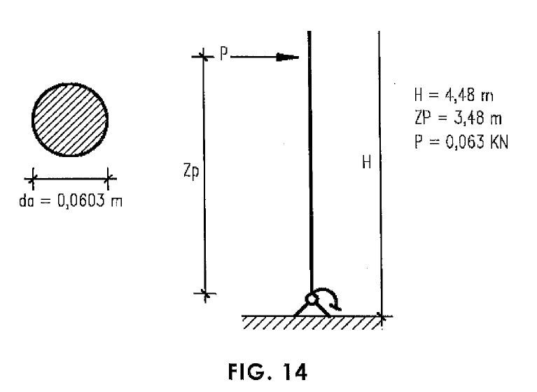

A similar comparative computation for a mast with a solid cross section is realized in the following (see FIG. 14 which represents the geometry of a steel mast with solid cross section). The steel mast is again 4.48 m tall and it has a diameter of 60.3 mm. The material and mast properties are indicated in the following two tables titled “Material Properties” and “Mast Properties”, respectively. With the numerical simulation applying the SAP2000 software, a torsion spring stiffness is again defined. The first natural frequency of the system computed with the software program SAP2000 is utilized as input for the MaSTaPsoftware program.

### Material Properties:

| Density [to/m³] | E-Modules [kN/m²] |
|---|---|
| 7.846 | 2.1*10⁸ |

### Mast Properties

| Frequency | Mass | Diameter | Taper |
|---|---|---|---|
| [Hz] | [to] | [m] | [—] |
| 1.51 | 0.098 | 0.0603 | 0.0 |

At an elevation of 3.48 m, a horizontal load is then introduced, and it is at this elevation where the displacement is then calculated. Computing the displacement is realized both in the software program SAP2000 and by applying the MaSTaP software program. The following table shows a comparison of the results. Accordingly, again two different oscillation patterns have been assumed for the bending portion (parabolic and sinusoidal).

### Comparison of Results:

| | Horizontal | Torsional | Frequency with |
|---|---|---|---|
| | Displacement | Spring Stiffness | full Restraint |
| | [m] | [kN/m] | [Hz] |
| SAP2000 | 0.0143 | 100.00 | 2.26 |
| MaSTaP* | 0.0147 | 92.756 | 2.35 |
| Discrepancy | 2.7% | 7.2% | 3.8% |
| MaSTaP** | 0.0155 | 84.485 | 2.51 |
| Discrepancy | 7.7% | 15.5% | 10% |

*Own bending shape with sinusoidal outset
**Own bending shape with parabolic outset

For the case chosen here, too, the results with the sinusoidal outset demonstrate better congruence with the theoretical result (SAP2000). The discrepancy with the horizontal displacement which is decisive for the evaluation merely amounts to 2.7%. Since the displacement is slightly overestimated here, too, the result moreover lies on the safe side.

The following table shows the further results obtained from the MaSTaP software program. Indicated are the stiffness portions for bending and rotation, the overall stiffness for the generalized system at the mast head as well as the deformation portions.

The results from the MaSTaP software program:

| | Stiffness | Stiffness | Total | Def_bieg | Def_Rot | |
|---|---|---|---|---|---|---|
| | due to Bending | due to Rotation * | Stiffness | Height zp | Height zp | gen_masse |
| | [kN/m] | [kN/m] | [kN/m] | [m] | [m] | [to] |
| ¹ | 4.8658 | 4.8352 | 2.4252 | 0.0065 | 0.0082 | 0.0269 |
| ² | 4.8658 | 4.4039 | 2.3117 | 0.0065 | 0.009 | 0.0257 |

¹ Own bending shape with sinusoidal outset
² Own bending shape with parabolic outset
* Equivalent stiffness at elevation H due to elastic restraint.

The displacement for the assumption of a sinusoidal oscillation pattern at elevation H results at 44% from bending and at 56% from rotation.

For further validation, force-path-measurements were carried out on selected masts. To this effect, a defined horizontal force was introduced of a certain elevation into the mast. The pertinent displacement at the elevation of the load was measured.

Frequency measurements have then be taken for the same mast, and the displacement has been computed for the same load by the aid of the program MaSTaP.

The congruence between directly measured displacements and those displacements determined from the frequency measurement is good. Discrepancies range at maximally 10% although the measurements have been taken on lumber masts with which a broad scattering of material characteristics usually exists.

The following tables show a comparison of measured displacements due to a single load with the arithmetically determined displacements which were derived from the system stiffnesses determined from the frequency measurement.

| | | | | | | | | | | | | | Load | |
|---|---|---|---|---|---|---|---|---|---|---|---|---|---|---|
| | | | | | | | | | | | | | Intro- | |
| | | | | | | | | | zp EL. | | | Horizontal | duction | |
| | | | Outer | Shell | | | Eleva- | | Load | | | Displace- | Computed | |
| | | Circum- | Diam- | Thick- | Moist- | Mast | tion | f | intro- | | | ment | Total Defor- | |
| Mate- | Cross | ference | eter | ness | ure | Lenght | EOK | measured | duction | load | Load | measured | mation | Discrep- |
| rial | Section | in mm | in mm | in mm | in % | m | m | Hz | m | in kg | N | In mm | in mm | ancy |
| Pine | Circular | 310.00 | 98.7 | | 4.5 | 4.000 | 3.200 | 5.763 | 3.015 | 6.5 | 63.8 | 18.0 | 19.2 | 1.07 |
| | Solid | | | | | | | | | | | | | |
| | Cross | | | | | | | | | | | | | |
| | Section | | | | | | | | | | | | | |
| Pine | Circular | 310.00 | 98.7 | | 4.5 | 4.000 | 3.200 | 5.763 | 3.015 | 13.0 | 127.5 | 34.0 | 36.9 | 1.09 |
| | Solid | | | | | | | | | | | | | |
| | Cross | | | | | | | | | | | | | |
| | Section | | | | | | | | | | | | | |
| Pine | Circular | 310.00 | 98.7 | | 4.5 | 4.000 | 3.200 | 5.763 | 3.015 | 19.5 | 191.3 | 52.0 | 56.1 | 1.08 |
| | Solid | | | | | | | | | | | | | |
| | Cross | | | | | | | | | | | | | |
| | Section | | | | | | | | | | | | | |
| Steel | Circular | 190.0 | 60.5 | 2.3 | 0 | 5.060 | 4.380 | 2.67 | 3.48 | 6.5 | 63.8 | 32.0 | 33.2 | 1.04 |
| | Ring | | | | | | | | | | | | | |
| | Cross | | | | | | | | | | | | | |
| | Section | | | | | | | | | | | | | |
| Steel | Circular | 191.0 | 60.8 | 2.3 | 0 | 5.060 | 4.380 | 2.67 | 3.48 | 13.0 | 127.5 | 61.0 | 63.1 | 1.03 |
| | Ring | | | | | | | | | | | | | |
| | Cross | | | | | | | | | | | | | |
| | Section | | | | | | | | | | | | | |

Congruence of results is good. The maximal discrepancies lie under 10%. The discrepancies with steel masts are substantially less, which is attributable to the more homogeneous material.

These results were still determined with a predefined oscillation pattern. The test with a modified program version which utilized specific oscillation patterns have lead to another improvement of congruence.

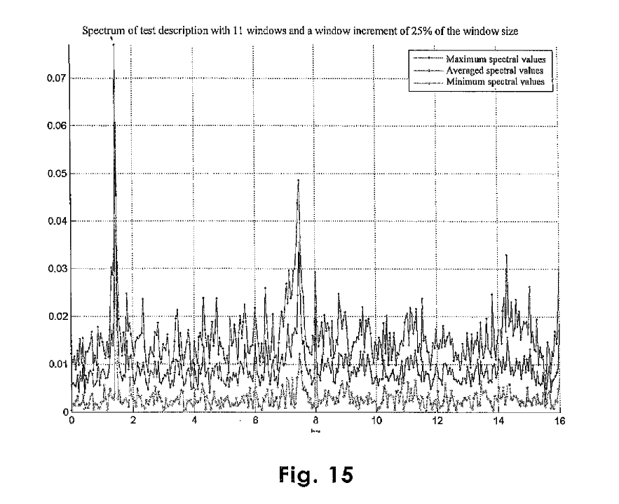

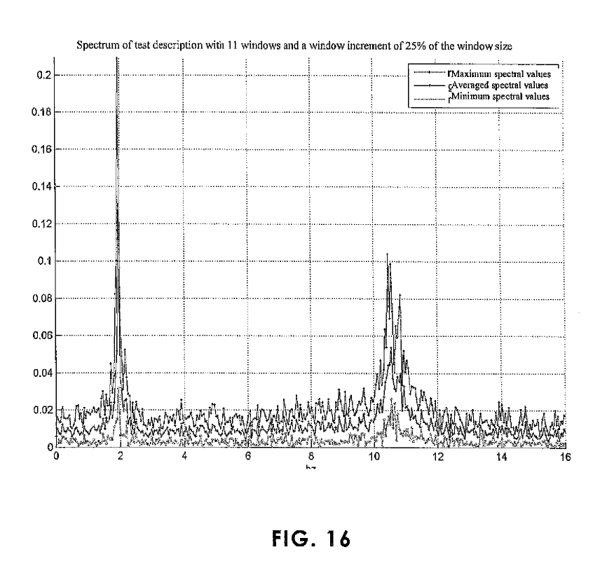

The results for two really measured and evaluated masts are presented in the following. FIGS. 15 and 16 show the measured frequency spectrae of accelerations. FIG. 15 shows the result of an acceleration spectrum for a mast 1 with a measured natural frequency fe=1,368 Hz. FIG. 16 shows the result of an acceleration spectrum for a mast 2 with a measured natural frequency fe=1,953 Hz. The peaks with the first and the second natural frequency can be clearly recognized.

Mast 2 is evaluated once without wire ropes and once with wire ropes. The evaluation without ropes demonstrates that the ropes exert a marked influence on the correct evaluation. In this case, mast 2 with ropes is to be classified into class 2, whereas it would have been classified in class 1 without ropes. However, since it was measured with ropes, class 2 is the correct classification. The ropes take the effect of enhancing the stiffness. However, since the wind loads to be assumed increase significantly (due to the wind load impact on the ropes), a larger deformation occurs in total which entails a classification into a worse class.

The comparison with the evaluations which are based upon a merely visual assessment of the mast status demonstrates good congruence.

| | | Mast 1 | Mast 2 | Mast 2 |
|---|---|---|---|---|
| Voltage | (NS = low voltage) | NS | NS | NS |
| Wire rope attachment, cross section | in mm² | 35 | 35 | 35 |
| Wire rope weight (density) | kg/m³ | 3560 | 3560 | 3560 |
| Sagging, at left | in m | 0.65 | 0 | 0.55 |
| Sagging, at right | in m | 0.65 | 0 | 0.55 |
| Wood/lumber type | (KI = pine) | KI | KI | KI |
| Mast type | (T = load-bearing mast) | T | T | T |
| Mast length (nominal length) | in m | 10.00 | 10.00 | 10.00 |
| Circumference at bottom | in cm | 67 | 72 | 72 |
| Diameter at bottom | in m | 0.214 | 0.230 | 0.230 |
| Diameter at top | in m | 0.181 | 0.197 | 0.197 |
| Year built | | 1977 | 1979 | 1979 |
| Elevation H GOK (Terrain Top Edge) | in m | 8.40 | 8.25 | 8.25 |
| Field length at left LL | in m | 45 | 39 | 39 |
| Field length at right LR | in m | 45 | 39 | 39 |
| Mast pattern | 1 = 3 wire ropes | 1 | 0 | 1 |
| Elevation lowest phase above GOK | in m | 6.9 | 0 | 7.0 |
| Remarks | | | Mast without | |
| | | | wire ropes | |
| Temperature | in ° C. | 13.5 | 13.5 | 13.5 |
| Moisture at base | in % | 17.3 | 16.4 | 16.4 |
| Moisture at shaft | in % | 13.1 | 13.9 | 13.9 |
| Natural frequency measured | in Hz | 1.368 | 1.953 | 1.953 |
| Natural frequency for full restraint | in Hz | 1.850 | 2.431 | 2.431 |
| (non-corrected) | | | | |
| E-modules (initial value) | in kN/m² | 1.10E+07 | 1.10E+07 | 1.10E+07 |
| Corrected E-module (including | in kN/m² | 1.34E+07 | 1.32E+07 | 1.32E+07 |
| moisture impact and age factor) | | | | |
| Density (initial value) | in t/m³ | 0.520 | 0.520 | 0.520 |
| Density (including moisture correction) | in t/m³ | 0.525 | 0.529 | 0.529 |
| Age factor | | 1.257 | 1.249 | 1.249 |
| Natural frequency for full restraint | in Hz | 2.072 | 2.717 | 2.717 |
| (corrected) | | | | |
| Flexural stiffness (corrected) | in kN/m | 6.297 | 8.854 | 8.854 |
| Overall stiffness | in kN/m | 3.288 | 5.384 | 7.201 |
| Wind zone | | 2 | 2 | 2 |
| Wind load (sum on overall system) | in kN | 2.31 | 1.44 | 2.36 |
| Heat point displacement max. y | in m | 0.396 | 0.099 | 0.194 |
| due to wind load | | | | |
| Rel. displacement max y/H GOK | | 4.72% | 1.20% | 2.35% |
| Class 1 adm. Max y/H GOK | | 1.50% | 1.50% | 1.50% |
| Class 2 adm. Max y/H GOK | | 3.00% | 3.00% | 3.00% |
| Class 3 adm. Max y/H GOK | | 5.00% | 5.00% | 5.00% |
| MaSTaP Evaluation | | 3 | 1 | 2 |
| Base status | Visual assessment | 3 | 2 | 2 |
| Shaft status | | 3 | 2 | 2 |
| Head status | | 3 | 2 | 2 |
| Mast status | | 3 | 2 | 2 |

The basis for the inventive method is the fact that the natural frequencies which can be determined by oscillation measurements contain data and information on the system stiffness and on the co-oscillating mass. The co-oscillating mass of the systems is determined so that the only unknown variable still left is the system stiffness. Hence, by way of the measured natural frequencies, conclusions as to system stiffness can be drawn well.

By the aid of the measuring results, a numerical system of the real mast is calibrated, for example in a computer. This is accomplished in particular by adjusting the stiffness of a virtually assumed torsion spring. Hence the torsion spring is allocated all the influences taking a stiffness-diminishing effect. It does not matter at what place in the system damages do exist, for example. Detailed comparative computations (simplified system with a calibrated torsion spring and detailed systems with damages at various places of the mast) have demonstrated that this method is sufficiently exact in order to conclusively compute the head displacements at a numerical system thus calibrated.

For the measurements, the masts are excitated manually, for example, and the system responses are measured with appropriate sensors. The evaluation of these data can be performed automatically in a computer by applying a suitable software after all the required parameters (e.g. geometry of the mast, material, etc.) have been entered.

A software of this kind computes the maximal displacements and/or deflections at the mast head for various load cases. Such a displacement is then taken recourse to and utilized for the assessment and evaluation. For lumber masts, a differentiation is made between several classes, preferably between 4 classes.

The method is suitable for a plurality of mast types and mast materials.

### 2. LITERATURE

[1] Petersen, Ch.: Dynamik der Baukonstruktionen; Neubiberg, 1996
[2] EN 40, Lichtmaste, Teile 3.1-3.3, DIN, 2005
[3] VDE 0210, Freileitungen über AC-45 kV, Teile 1-12, 2007
[4] DIN 1055-4, Einwirkungen auf Tragwerke—Teil 4 Windlasten, DIN 2005
[5] prEN14229:2007, Structural timber—Wood Poles for overhead lines, European Standard, Technical Committee CEN/TC 124, 2007
[6] Neuhaus Helmut, Lehrbuch des Ingenieurholzbaus, B. G. Teubner 1994
[7] Neuhaus, H.: Elastizitätszahlen von Fichtenholz in Abhängigkeit von der Holzfeuchtigkeit, Diss., in: technisch-wissenschaftliche Mitteilungen, Nr 81-8, Inst. für konstruktiven Ingenieurbau, Ruhr-Universität-Bochum, 1981
[8] Neuhaus, H.: Über das elastische Verhalten von Fichtenholz in Abhängigkeit von der Holzfeuchtigkeit, Holz als Roh-und Werkstoff 41 (1983), S. 21-25
[9] Neuhaus, H.: Über das elastische Verhalten von Holz und Kunststoffen, in: Strathrnann, L. (Hrsg.), Ingenieurholzbau, Fachtagung, FB Bauingenieurwesen, Münster: FH, 1987
[10] Noack D., Geissen, A.: Einfluss von Temperatur und Feuchtigkeit auf den E-Modul des Holzes im Gefrierbereich, Holz als Werkstoff 34 (1976), S. 55-62
[11] Möhler, K.: Grundlagen der Holz-Hochbaukonstruktionen, in: Götz K.-H., Hoor D., Möhler K., Natterer J.; Holzbauatlas, München Inst. Für internationale Architektur-Dokumentation, 1980
[12] David W. Green, Jerrold E. Winandy, and David E. Kretschmann: Mechanical Properties of Wood, Forest Products Laboratory. 1999. Wood handbook—Wood as an engineering material, .Gen. Tech. Rep. FPL-GTR-113. Madison, Wis.: U.S. Department of Agriculture, Forest Service, Forest Products Laboratory. 463 p.

1. Method for testing the stability of a standing system, more particularly a mast, in which a natural frequency of a mast to be examined is determined,
wherein
by the aid of the natural frequency a measure for the stability is computationally and/or numerically determined and wherein the stability is evaluated on the basis of the measure determined.

2. Method according to claim 1 in which the deflection of the mast is determined on the basis of an external load as a measure for stability.

3. Method according to claim 1, in which the measure for stability is determined by considering system parameters of the mast.

4. Method according to claim 1, in which the measure for stability is determined by considering the weights which a mast has to bear including its deadweight.

5. Method according to claim 1, in which the measure for stability is determined by considering at least one height of a weight which a mast to be examined has to bear.

6. Method according to claim 1, in which the measure for stability is determined by considering at least one magnitude and/or shape of a weight which a mast to be examined has to bear.

7. Method according to claim 1, in which the measure for stability is determined by considering a temperature-dependent wire rope sagging.

8. Method according to claim 1, in which the measure for stability is determined by considering the generalized mass of the mast, more particularly in conformity with
$${Ω}^{2} ∼ \frac{1}{generalized mass}$$
where Ω=2·natural frequency fₑ,
and more preferably in conformity with
$${Ω}^{2} ∼ \frac{{C}_{gen}}{generalized mass}$$
where C_{gen}=generalized stiffness.

9. Method according to claim 1, in which the measure for stability is determined by considering the material moisture of the mast.

10. Method according to claim 1, in which the measure for stability is determined by considering the age of the mast.

11. Method according to claim 1, in which the measure for the stability of a mast with wire rope attachments is determined by considering the forces exerted through the wire ropes onto the mast.

12. Method according to claim 1, in which the measure for the stability of a mast with electrically live wire rope attachments is determined by considering the electrical power conducted through the wire rope attachments.

13. Method according to claim 1, in which the measure for the stability of a mast with electrically live wire rope attachments is a deflection of the mast due to an external load exerted perpendicularly to the run of a wire rope carried by the mast.

14. Method according to claim 1, in which for determination of a natural frequency of a mast to be examined those vibrations are initially recorded which originate from natural environmental influences, and subsequently recording those vibrations which result from an artificial excitation.

15. Method according to claim 1, in which for the determination of a natural frequency of the mast to be examined only those vibrations are recorded which do not exceed a defined upper limit for a vibration frequency.

16. Method more particularly according to claim 1, in which the torsional stiffness of a mast to be examined is determined in order to evaluate the stability of the mast based on this result.

17. Device for implementing the method according to claim 1 with a computational unit so programmed that upon entry of input information and/or system parameters required a measure for the stability as searched for is determined in an automatized manner.

18. Device according to claim 1 with acceleration sensors and means for transferring vibrations determined by the sensors to the computational unit.

19. Device according to claim 1 with moisture sensors to measure the material moisture of a mast as well as with means for transferring material moisture values to the computational unit.

20. Device according to claim 1 with output means for the output of a test result on the stability of a mast.
